(19) United States
(12) Patent Application Publication
(10) Pub. No.: US 2026/0161240 A1
(43) Pub. Date: Jun. 11, 2026

(54) INPUT DEVICE, DISPLAY PANEL, AND ELECTRONIC DEVICE

(71) Applicant: Samsung Display Co., Ltd., Yongin-si (KR)

(72) Inventor: SANGHYUN LIM, Yongin-si (KR)

(21) Appl. No.: 19/328,873

(22) Filed: Sep. 15, 2025

(30) Foreign Application Priority Data
Dec. 10, 2024 (KR) 10-2024-0182556

(51) Int. Cl. G06F 3/038; G06F 3/0354; G06F 3/044

(52) U.S. Cl. CPC G06F 3/0383; G06F 3/03545; G06F 3/0442

(57) ABSTRACT

An input device includes: a housing including a body portion and a tapered portion including a pen tip; a first connection line inside the housing and extending from the body portion toward the pen tip of the tapered portion; a first tip electrode inside the housing and connected to the first connection line to face the pen tip; a second tip electrode inside the housing, having an opening allowing the first connection line to pass through the opening, and surrounding the first connection line; a second connection line inside the housing, connected to the second tip electrode, and extending toward the body portion; a ground electrode inside the housing and surrounding the first connection line and the second connection line; and a ring electrode inside the housing and surrounding the ground electrode.

### CROSS-REFERENCE TO RELATED APPLICATIONS

The present application claims priority to and the benefit of Korean Patent Application No. 10-2024-0182556, filed on Dec. 10, 2024, in the Korean Intellectual Property Office, the entire disclosure of which is incorporated herein by reference.

### BACKGROUND

Aspects of some embodiments of the present disclosure described herein relate to an input device, a display panel, and an electronic device.

Multimedia electronic devices, such as a television, a cellular phone, a tablet computer, a navigation system, and a game console, include a display device that displays an image. Electronic devices may include an sensor layer (or an input sensor) that provide a touch-based input manner for enabling a user to intuitively, conveniently, and easily input information or a command, in addition to a general input manner, such as a button, a keyboard, or a mouse. The sensor layer may sense a touch or pressure that uses a body of the user. Meanwhile, there is an increasing demand for using a pen (or an input device) for a fine touch input for the user who is accustomed to entering information by using writing instruments or for a specific application (for example, application program for sketching or drawing).

The above information disclosed in this Background section is only for enhancement of understanding of the background and therefore the information discussed in this Background section does not necessarily constitute prior art.

### SUMMARY

Aspects of some embodiments of the present disclosure include an input device, a display panel, and an electronic device that may have relatively improved precision.

According to some embodiments, an input device may include a housing including a body portion and a tapered portion including a pen tip, a first connection line inside the housing and extending from the body portion toward the pen tip of the titling unit, a first tip electrode inside the housing and connected to the first connection line to face the pen tip, a second tip electrode inside the housing, having an opening defined in the second tip such that the first connection line passes through the opening, and surrounding the first connection line, a second connection line inside the housing, connected to the second tip electrode, and extending toward the body portion, a ground electrode inside the housing to surround the first connection line and the second connection line, and a ring electrode inside the housing to surround the ground electrode.

According to some embodiments, the first tip electrode may output a first signal, the second tip electrode may output a second signal, and an intensity of the first signal may be lower than an intensity of the second signal.

According to some embodiments, the input device may include a first voltage source inside the housing to provide a first voltage signal to the first tip electrode, and a second voltage source to provide a second voltage signal to the second tip electrode.

According to some embodiments, each of the first voltage signal and the second voltage signal may be configured to be converted through a control signal.

According to some embodiments, the first voltage signal may have a frequency equal to a frequency of the second voltage signal, and the first voltage signal and the second voltage signal may be in phase.

According to some embodiments, the first voltage signal may have an amplitude less than an amplitude of the second voltage signal.

According to some embodiments, a time period for providing the first voltage signal may be shorter than a time period for providing the second voltage signal, within the same time duration.

According to some embodiments, the input device may include a controller configured to separately control a frequency, an amplitude, a phase, and an output timing of the first voltage signal and a frequency, an amplitude, a phase, and an output timing of the second voltage signal.

According to some embodiments, the input device may further include a voltage source in the housing and configured to provide a tip voltage signal to the first tip electrode and the second tip electrode, and a voltage division circuit interposed between the voltage source and the first connection line.

According to some embodiments, the input device may further include a switching circuit interposed between the voltage source and the voltage division circuit to control a connection between the voltage source and the voltage division circuit.

According to some embodiments, at least one of the tip voltage signal, the switching circuit, or the voltage division circuit may be controlled through a control signal.

According to some embodiments, the voltage division circuit may include a first resistor connected between the switching circuit and the first connection line, and a second resistor connected between a node, which is interposed between the first resistor and the first connection line, and a ground terminal, one of the first resistor and the second resistor may be variable resistor, and a resistance of the variable resistor may be adjusted through the control signal.

According to some embodiments of the present disclosure, a display panel may include a display layer to display an image, and a sensor layer on the display layer. According to some embodiments, the sensor layer may output a first signal received from an outside and a second signal received from the outside and different from the first signal. According to some embodiments, the first signal and the second signal may be used to calculate the position of a pen tip.

According to some embodiments, the first signal may have a frequency equal to a frequency of the second signal, the first signal and the second signal may be in phase, and the first signal may have an amplitude less than an amplitude of the second signal.

According to some embodiments, each of the first signal and the second signal may be an alternating current (AC) signal, and a length of a duration in which the first signal has a waveform may be shorter than a length of a duration in which the second signal has a waveform.

According to some embodiments, the sensor layer may output a third signal different from the first signal and the second signal and received from the outside, and the third signal may be used to correct a position of the pen tip.

According to some embodiments of the present disclosure, an electronic device may include a display panel including a display layer to display an image, and a sensor layer on the display layer, a display driver configured to control the operation of the display layer, a sensor driver configured to control the operation of the sensor layer and to calculate information about a position of a pen tip, based on the first signal provided from the sensor layer and a second signal different from the first signal, and a main driver configured to control the operation of the display driver and the operation of the sensor driver and to control the operation of the display driver, based on a coordinate signal provided from the sensor driver.

According to some embodiments, the first signal may have a frequency equal to a frequency of the second signal, the first signal and the second signal may be in phase, and the first signal may have an amplitude less than an amplitude of the second signal. According to some embodiments, the sensor driver may be configured generate the coordinate signal based on information obtained by adding the first signal and the second signal.

According to some embodiments, each of the first signal and the second signal may be an alternating current (AC) signal, and a length of a duration in which the first signal has a waveform may be shorter than a length of a duration in which the second signal has a waveform, and the sensor driver may be configured to generate the coordinate signal based on information obtained by adding the first signal and the second signal.

According to some embodiments, the sensor driver may be configured to receive a third signal different from the first signal and the second signal and provided from the sensor layer, and to correct a position of the pen tip, based on the third signal.

### BRIEF DESCRIPTION OF THE DRAWINGS

The above and other aspects and features of embodiments according to the present disclosure will become more apparent by describing in more detail aspects of some embodiments thereof with reference to the accompanying drawings.

FIG. 1A is a perspective view of an electronic device set according to some embodiments of the present disclosure.

FIG. 1B is a rear perspective view of an electronic device according to some embodiments of the present disclosure.

FIG. 2 is a perspective view of an electronic device according to some embodiments of the present disclosure.

FIG. 3 is a perspective view of an electronic device according to some embodiments of the present disclosure.

FIG. 4 is a schematic cross-sectional view of an electronic device according to some embodiments of the present disclosure.

FIG. 5 is a view describing an operation of an electronic device according to some embodiments of the present disclosure.

FIG. 6 is a cross-sectional view of a display panel according to some embodiments of the present disclosure.

FIG. 7 is a block diagram of a display layer and a display driver according to some embodiments of the present disclosure.

FIG. 8 is a block diagram of a sensor layer and a sensor driver according to some embodiments of the present disclosure.

FIG. 9 is a plan view illustrating one node according to some embodiments of the present disclosure.

FIG. 10 is a block diagram schematically illustrating an input device according to some embodiments of the present disclosure.

FIG. 11 is a cross-sectional view of a portion of an input device according to some embodiments of the present disclosure.

FIG. 12 illustrates graphs representing a coupling capacitance as a function of a position of an input device according to some embodiments of the present disclosure.

FIG. 13 is a view illustrating an input device according to some embodiments of the present disclosure.

FIG. 14 is a view illustrating voltage signals provided to a first tip electrode, a second tip electrode, and a ring electrode according to some embodiments of the present disclosure.

FIG. 15 is a view illustrating voltage signals provided to a first tip electrode, a second tip electrode, and a ring electrode according to some embodiments of the present disclosure.

FIG. 16 is a view illustrating voltage signals provided to a first tip electrode, a second tip electrode, and a ring electrode according to some embodiments of the present disclosure.

FIG. 17 is a view illustrating voltage signals provided to a first tip electrode, a second tip electrode, and a ring electrode according to some embodiments of the present disclosure.

FIG. 18 is a view illustrating an input device according to some embodiments of the present disclosure.

FIG. 19 is a view illustrating an input device according to some embodiments of the present disclosure.

FIG. 20 is a view illustrating an input device according to some embodiments of the present disclosure.

FIG. 21 is a view illustrating an input device according to some embodiments of the present disclosure.

FIG. 22 is a view illustrating an input device according to some embodiments of the present disclosure.

FIG. 23 is a view illustrating an input device according to some embodiments of the present disclosure.

FIG. 24 is a view illustrating an input device according to some embodiments of the present disclosure.

FIG. 25 is a view illustrating an input device according to some embodiments of the present disclosure.

FIG. 26 is a block diagram of an electronic device according to some embodiments of the present disclosure.

FIG. 27 illustrates schematic views of an electronic device according to some embodiments.

### DETAILED DESCRIPTION

In the specification, the expression that a first component (or region, layer, or part) is “on”, “connected to”, or “coupled to” a second component refers to that the first component is directly on, connected to, or coupled to the second component or refers to that a third component is interposed therebetween.

The same reference numeral will be assigned to the same component. In addition, in drawings, thicknesses, proportions, and dimensions of components may be exaggerated to describe the technical features effectively. The term “and/or” includes any and all combinations of one or more of associated components

[symbol]

Although the terms “first”, or “second” may be used to describe various components, the components should not be construed as being limited by the terms. The terms are only used to distinguish one component from another component. For example, without departing from the scope and spirit of the present disclosure, a first component may be referred to as a second component, and similarly, the second component may be referred to as the first component. The singular forms are intended to include the plural forms unless the context clearly indicates otherwise.

In addition, the terms “under”, “at a lower portion”, “above”, and “an upper portion” are used to describe the relationship between components illustrated in drawings. The terms are relative and will be described with reference to a direction indicated in the drawing.

It will be further understood that the terms “comprise,” “include,” or “including,” or “have” or “having” specify the presence of stated features, numbers, steps, operations, components, parts, or the combination thereof, but do not preclude the presence or addition of one or more other features, numbers, steps, operations, components, components, and/or the combination thereof.

The terms “part” and “unit” refer to a software component or a hardware component to perform a specific function. The hardware component may include field-programmable gate array (FPGA) or an application-specific integrated circuit (ASIC). The software component may refer to an executable code and/or data used by the executable code in an addressable storage medium. Accordingly, software components may be, for example, object-oriented software components, class components, and task components, and may include processes, functions, properties, procedures, subroutines, program code segments, driver data, firmware, micro-codes, circuits, data, database, data structures, tables, arrangements or variables.

Unless defined otherwise, all terms (including technical terms and scientific terms) used in the specification have the same meaning as commonly understood by one skilled in the art to which the present disclosure belongs. Furthermore, terms such as terms defined in the dictionaries commonly used should be interpreted as having a meaning consistent with the meaning in the context of the related technology, and should not be interpreted in ideal or overly formal meanings unless explicitly defined herein.

Hereinafter, aspects of some embodiments of the present disclosure will be described in more detail with reference to drawings.

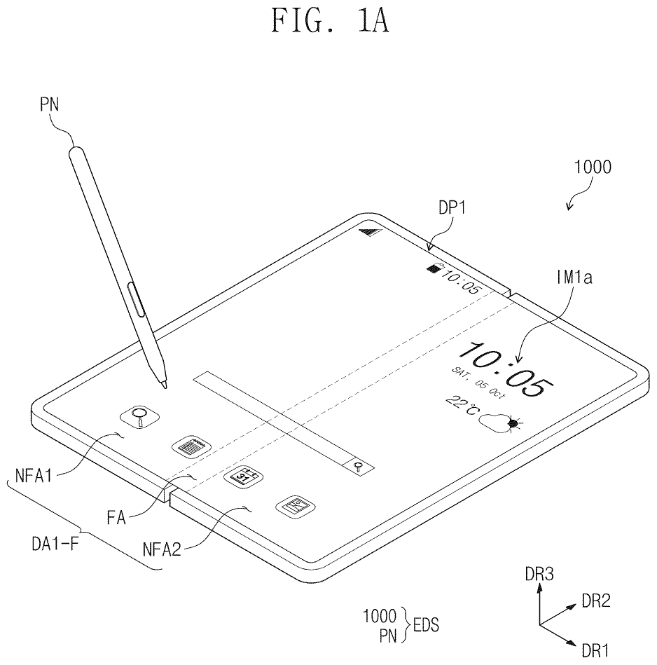

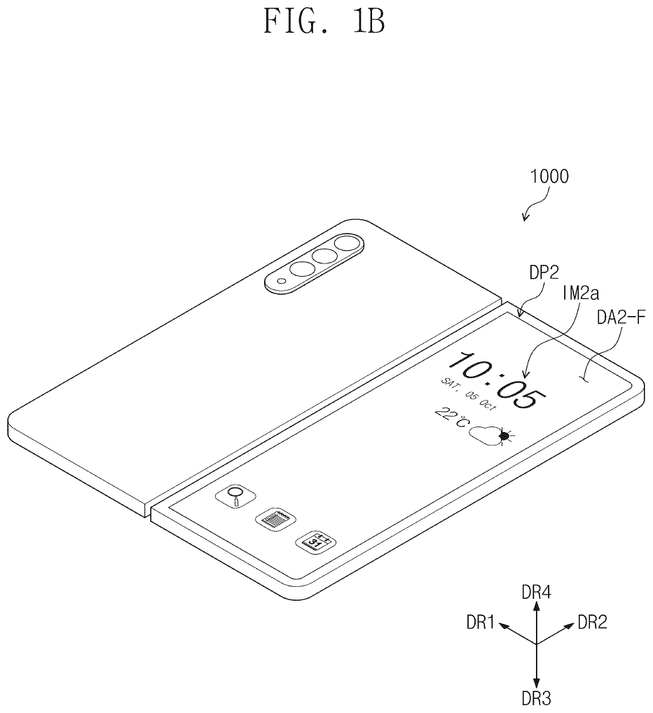

FIG. 1A is a perspective view of an electronic device set EDS according to some embodiments of the present disclosure. FIG. 1B is a rear perspective view of an electronic device 1000 according to some embodiments of the present disclosure.

Referring to FIGS. 1A and 1B, the electronic device set EDS may include the electronic device 1000 and an input device PN. The electronic device set EDS may be referred to as an “electronic device package”, an “electronic device combo”, or an “electronic set”. The input device PN may make communication with or be paired with the electronic device 1000. The electronic device 1000 may be configured to receive a signal provided from the input device PN, and the input device PN may be configured to receive a signal provided from the electronic device 1000.

The electronic device 1000 may be a device which is activated in response to an electrical signal. For example, the electronic device 1000 may display images and sense inputs applied from the outside. The external input may be an input of a user. The input of the user may include various types of external inputs such as a part of a user body, the input device PN, a light, heat, and pressure.

The electronic device 1000 may include a first display panel DP1 and a second display panel DP2. The first display panel DP1 and the second display panel DP2 may be independent panels that are separated from each other. The first display panel DP1 may be referred to as a “main display panel”, and the second display panel DP2 may be referred to as an “auxiliary display panel” or an “external display panel”.

The first display panel DP1 may include a first display unit DA1-F and the second display panel DP2 may include a second display unit DA2-F. The area of the second display panel DP2 may be less than the area of the first display panel DP1. The area of the first display unit DA1-F, which corresponds to the size of the first display panel DP1, may be larger than the area of the second display unit DA2-F which corresponds to the size of the second display panel DP2.

The first display unit DA1-F may have a plane parallel (or substantially parallel) to a plane defined by a first direction DR1 and a second direction DR2, when the electronic device 1000 is unfolded. A thickness direction of the electronic device 1000 may be parallel to a third direction DR3 crossing the first direction DR1 and the second direction DR2. Accordingly, a front surface (or top surface) and a rear surface (or bottom surface) of members constituting the electronic device 1000 may be defined based on the third direction DR3.

The first display panel DP1 or the first display unit DA1-F may include a folding region FA being folded and unfolded, and a plurality of non-folding regions NFA1 and NFA2 spaced apart from each other while interposing the folding region FA between the non-folding regions NFA1 and NFA2. The second display panel DP2 may be overlapped with any one of the plurality of non-folding regions NFA1 and NFA2. For example, the second display panel DP2 may be overlapped with the first non-folding regions NFA1.

A display direction of a first image IM1a which is displayed on a portion (for example, the second non-folding region NFA2) of the first display panel DP1, may be opposite to a display direction of a second image IM2a which is displayed on the second display panel DP2. For example, the first image IM1a may be displayed in the third direction DR3, and the second image IM2a may be displayed in a fourth direction DR4 facing away from the third direction DR3.

According to some embodiments of the present disclosure, the folding region FA may be bent around a folding axis extending in a direction, which is, for example, a direction parallel to the second direction DR2, parallel to a longer side of the electronic device 1000. The folding region FA may have a specific curvature and a specific radius of curvature, when the electronic device 1000 is folded. The first non-folding region NFA1 and the second non-folding region NFA2 may face each other, and the electronic device 1000 may be in an inner-folding state, such that the first display unit DA1-F is not exposed to the outside.

According to some embodiments of the present disclosure, the electronic device 1000 may be in an outer-folding state such that the first display unit DA1-F is exposed to the outside. According to some embodiments of the present disclosure, the electronic device 1000 may be in the inner-folding state or the outer-folding state from the state in which the electronic device 1000 is unfolded, but embodiments according to the present disclosure are not limited thereto.

FIG. 1A illustrates that one folding region FA is defined (provided or included) in the electronic device 1000, but embodiments according to the present disclosure are not limited thereto. For example, a plurality of folding axes and a plurality of folding regions corresponding to the plurality of folding axes are defined in the electronic device 1000, and the electronic device 1000 may be in the inner-folding state or the outer-folding state from the state in which the electronic device 1000 is unfolded in each of the plurality of folding regions.

According to some embodiments of the present disclosure, at least one of the first display panel DP1 or the second display panel DP2 may sense an input made by the input device PN. The input device PN may be referred to as a pen, a stylus pen, or an active pen.

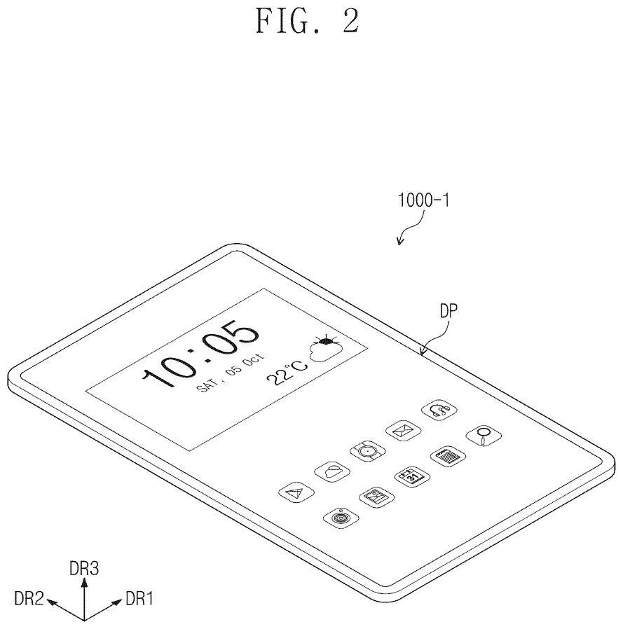

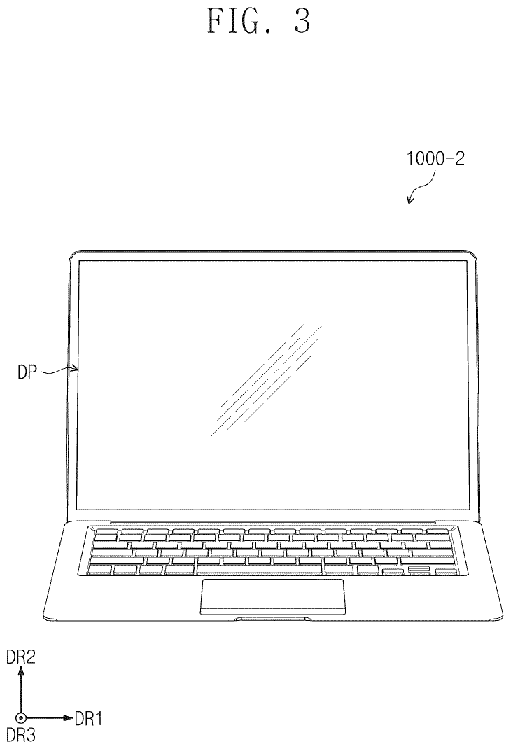

FIG. 2 is a rear perspective view of an electronic device 1000-1 according to some embodiments of the present disclosure. FIG. 3 is a rear perspective view of an electronic device 1000-2 according to some embodiments of the present disclosure.

Although FIG. 2 illustrates that the electronic device 1000-1 is a bar type of electronic device which is, for example, a cellular phone or a tablet PC, the electronic device 1000-1 may include the display panel DP. Although FIG. 3 illustrates that the electronic device 1000-2 is a laptop computer, the electronic device 1000-2 may include the display panel DP. Although FIG. 3 is a perspective view of the electronic device 1000-2, a coordinate axis included in FIG. 3 is expressed based on the display panel DP in the electronic device 1000-2.

According to some embodiments of the present disclosure, the display panel DP may sense inputs applied from the outside. The external input may be an input of a user. The input of the user may include various types of external inputs such as a part of a user's body, the input device PN (see FIG. 1A), light, heat, and pressure.

Although FIG. 1A illustrates the electronic device 1000 in a foldable type and FIG. 2 illustrates the electronic device 1000-1 in a bar type, the following description about embodiments according to the present disclosure are not limited thereto. For example, the following description may be applied to various electronic devices such as a rollable type of electronic device, a slidable type of electronic device, and a stretchable type of electronic device.

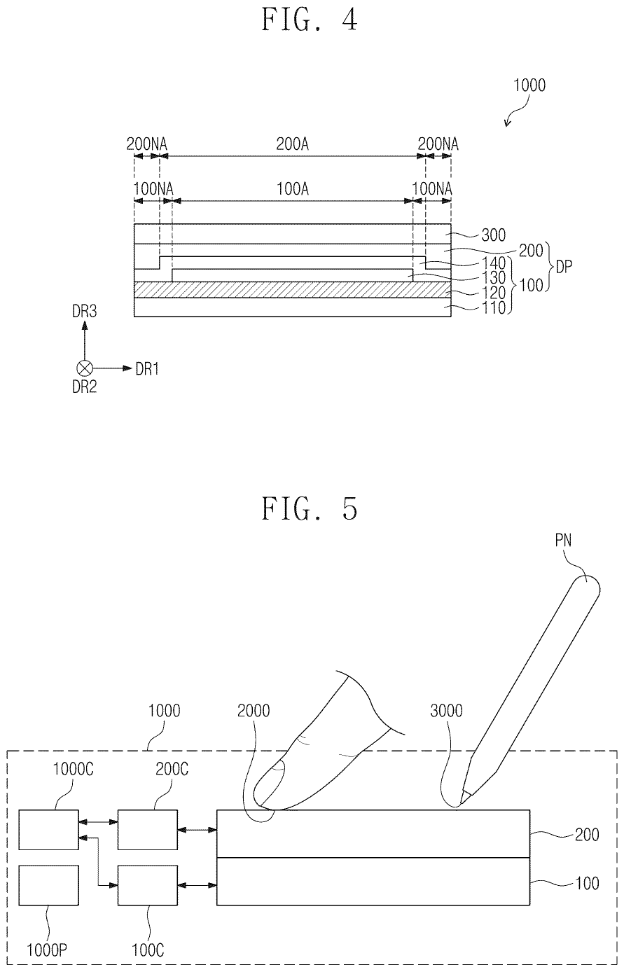

FIG. 4 is a schematic cross-sectional view illustrating the electronic device 1000 according to some embodiments of the present disclosure.

Referring to FIG. 4, the electronic device 1000 may include the display panel DP and a window module 300. The display panel DP may include a display layer 100 and a sensor layer 200.

The display layer 100 may be a component which generates images. The display layer 100 may include a display region 100A and a non-display region 100NA adjacent to the display region 100A. The images may be displayed on the display region 100A.

The display layer 100 may be a light emitting display layer. For example, the display layer 100 may be an organic light emitting display layer, an inorganic light emitting display layer, an organic-inorganic light emitting display layer, a quantum dot display layer, a micro-LED display layer, or a nano-LED display layer. The display layer 100 may include a base layer 110, a circuit layer 120, a light emitting element layer 130, and an encapsulating layer 140.

The base layer 110 may be a member which provides a base surface for forming or arranging the circuit layer 120. The base layer 110 may be of a multi-layer structure or a single-layer structure. The base layer 110 may be implemented with a glass substrate, a metal substrate, a silicon substrate, or a polymer substrate, but embodiments according to the present disclosure are not limited thereto.

The circuit layer 120 may be located on the base layer 110. The circuit layer 120 may include an insulating layer, a semiconductor pattern, a conductive pattern, or a signal line. The insulating layer, a semiconductor layer, and a conductive layer may be formed on the base layer 110 through a coating or deposition process, and may be selectively patterned through a plurality of photolithography processes.

The light emitting element layer 130 may be located on the circuit layer 120. The light emitting element layer 130 may include a light emitting element. For example, the light emitting element layer 130 may include an organic light emitting material, an inorganic light emitting material, an organic-inorganic light emitting material, a quantum dot, a quantum rod, a micro-LED, or a nano-LED.

The encapsulating layer 140 may be located on the light emitting element layer 130. The encapsulating layer 140 may protect the light emitting element layer 130 from foreign substances or contaminants such as moisture, oxygen, and dust particles.

The sensor layer 200 may be located on the display layer 100. The sensor layer 200 may include a sensing region 200A and a peripheral region 200NA adjacent to the sensing region 200A. The sensing region 200A may be overlapped with the display region 100A, and the peripheral region 200NA may be overlapped with the non-display region 100NA.

According to some embodiments of the present disclosure, the sensing region 200A may have an area larger than an area of the display region 100A. Accordingly, a portion of the sensing region 200A may be overlapped with the non-display region 100NA. However, embodiments according to the present disclosure are not limited thereto. The area of the sensing region 200A may be equal to the area of the display region 100A, or may be narrower than the area of the display region 100A.

The sensor layer 200 may sense an external input applied from the outside. The sensor layer 200 may be an integral type of sensor which is subsequently formed in the manufacturing process for the display layer 100, or may be an external sensor attached to the display layer 100. The sensor layer 200 may be referred to as a “sensor”, an “input sensing layer”, an “input sensing panel”, or an “electronic device dedicated to sense input coordinates”.

According to some embodiments of the present disclosure, the sensor layer 200 may sense both an input provided by a passive type input unit such as a user body and an input provided by an input device generating a specific signal or a magnetic field of a specific resonant frequency.

The window module 300 may be located on the sensor layer 200. According to some embodiments of the present disclosure, a functional layer, such as an anti-reflective layer may be further included between the window module 300 and the display panel DP.

The window module 300 may provide the highest surface of the electronic device 1000. The window module 300 may include a window and a protective film, but embodiments according to the present disclosure are not specially limited thereto. The window may be chemically tempered glass, but embodiments according to the present disclosure are not limited thereto.

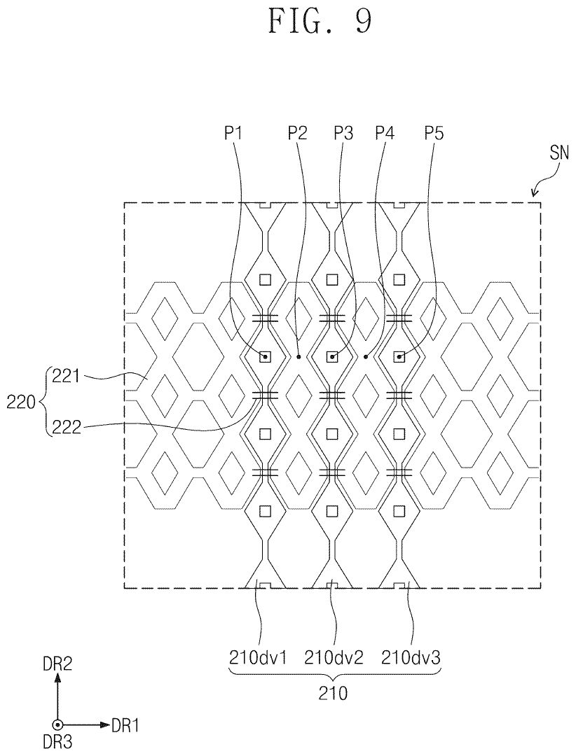

As the electronic device 1000 is implemented in a slim type, the distance between the highest surface of the window module 300 and the sensor layer 200 may be relatively reduced. As the distance is relatively reduced, the difference in distance between the input device PN (see FIG. 1A) and an internal pattern of the sensor layer 200 may be increased. In this case, the curve of a signal provided from the input device PN, which is received through the sensor layer 200, may be distorted, for example, in the shape of a first electrode 210 (see FIG. 9), instead of a normalized distribution. According to the present disclosure, even if the electronic device 1000 is implemented in the slim type, the input device PN having higher coordinates-precision (or position detection precision) is provided. The details thereof will be described later.

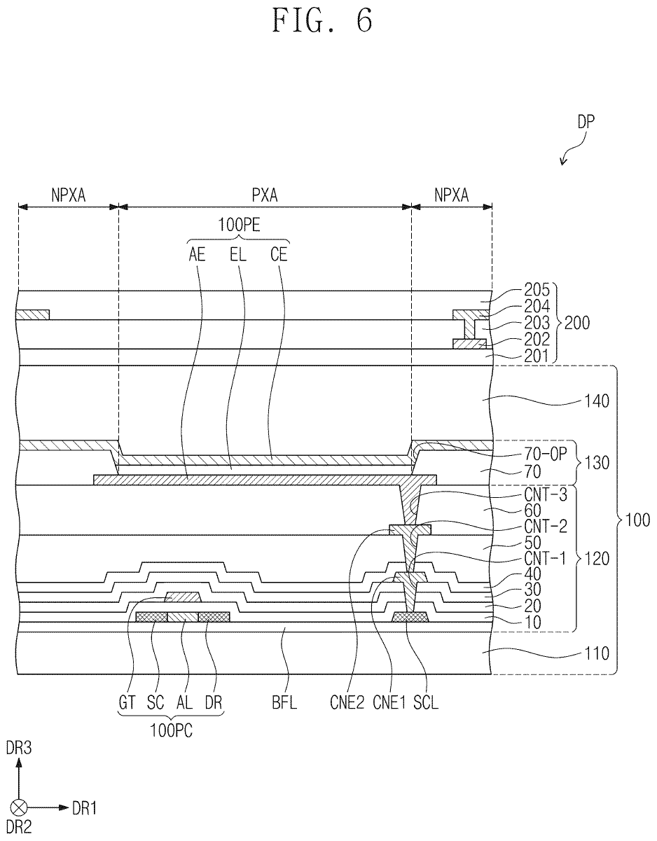

FIG. 5 is a view illustrating the operation of the electronic device 1000 according to some embodiments of the present disclosure.

Referring to FIG. 5, the electronic device 1000 may include the display layer 100, the sensor layer 200, a display driver 100C, a sensor driver 200C, a main driver 1000C, and a power supply circuit 1000P.

The sensor layer 200 may sense a first input 2000 or a second input 3000 applied thereto from an outside. Each of the first input 2000 and the second input 3000 may be an input by an input unit, which makes a change in capacitance of the sensor layer 200, or by an input unit to provide a driving signal to the sensor layer 200. For example, the first input 2000 may be an input by a passive type input unit such as a user body. The second input 3000 may be an input by the input device PN. For example, the input device PN may be an active type of pen providing the driving signal.

The main driver 1000C may control an overall operation of the electronic device 1000. For example, the main driver 1000C may control the operations of the display driver 100C and the sensor driver 200C. The main driver 1000C may include at least one microprocessor, and may further include a graphic controller. The main driver 1000C may be referred to as an application processor, a central processing unit, or a main processor.

The display driver 100C may control the display layer 100. The display driver 100C may receive image data and a control signal from the main driver 1000C. The control signal may include various signals. For example, the control signal may include an input vertical synchronization signal, an input horizontal synchronization signal, a main clock signal, and a data enable signal.

The sensor driver 200C may drive the sensor layer 200. The sensor driver 200C may receive a control signal from the main driver 1000C. The control signal may include a clock signal of the sensor driver 200C. In addition, the control signal may further include a mode determining signal for determining a driving mode of the sensor driver 200C and the sensor layer 200.

The sensor driver 200C may be integrated in the form of an integrated circuit (IC) and may be electrically connected to the sensor layer 200. For example, the sensor driver 200C may be directly mounted on a specific region of the display panel or mounted through a chip on film (COF) scheme on a separate printed circuit board such that the sensor driver 200C may be electrically connected to the sensor layer 200.

The sensor driver 200C and the sensor layer 200 may selectively operate in a first mode or a second mode. For example, the first mode may be a mode for sensing a touch input such as the first input 2000. The second mode may be a mode for sensing an input, such as the second input 3000, by the input device PN. The first mode may be referred to as a touch sensing mode, and the second mode may be referred to as a pen sensing mode.

The sensor driver 200C may calculate (detect) coordinate information (or position information) of an input based on the signal received from the sensor layer 200 and may provide a coordinate signal having the coordinate information to the main driver 1000C. The main driver 1000C executes an operation corresponding to a user input, in response to a coordinate signal. For example, the main driver 1000C may operate the display driver 100C such that a new application image is displayed on the display layer 100.

The power supply circuit 1000P may include a power management integrated circuit (PMIC). The power supply circuit 1000P may generate a plurality of driving voltages for driving the display layer 100, the sensor layer 200, the display driver 100C, and the sensor driver 200C. For example, the plurality of driving voltages may include a gate high voltage, a gate low voltage, a first driving voltage, a second driving voltage, or an initializing voltage.

FIG. 6 is a cross-sectional view of the display panel DP according to some embodiments of the present disclosure.

Referring to FIG. 6, at least one buffer layer BFL is formed on a top surface of the base layer 110. The buffer layer BFL may relatively improve a bonding force between the base layer 110 and a semiconductor pattern. The buffer layer BFL may be formed in a multi-layer structure. Alternatively, the display layer 100 may further include a barrier layer. The buffer layer BFL may include at least one of silicon oxide, silicon nitride, or silicon oxynitride. For example, the buffer layer BFL may include a structure in which a silicon oxide layer and a silicon nitride layer are stacked alternately.

A semiconductor pattern (SC, AL, DR, and SCL) may be located on the buffer layer BFL. The semiconductor pattern (SC, AL, DR, and SCL) may include polysilicon. However, embodiments according to the present disclosure are not limited thereto. For example, the semiconductor pattern (SC, AL, DR, and SCL) may include amorphous silicon, low-temperature polycrystalline silicon, or an oxide semiconductor.

FIG. 6 illustrates merely a portion of the semiconductor pattern (SC, AL, DR, and SCL), and the semiconductor pattern (SC, AL, DR, and SCL) may be further located in another region. The semiconductor patterns (SC, AL, DR, and SCL) may be arranged across pixels in compliance with a specific rule. The semiconductor pattern (SC, AL, DR, and SCL) may have various electrical properties depending a doping state. The semiconductor pattern (SC, AL, DR, and SCL) may include a first region (SC, DR, and SCL) having higher conductivity and a second region AL having lower conductivity. The first region (SC, DR, and SCL) may be doped with an N-type dopant or a P-type dopant. A P-type transistor may include a doping region doped with the P-type dopant, and an N-type transistor may include a doping region doped with the N-type dopant. The second region AL may be a non-doping region or a region doped at a concentration lower than a concentration of the first region (SC, DR, and SCL).

The conductivity of the first region (SC, DR, and SCL) may be greater than the conductivity of the second region AL and may serve as an electrode or a signal line. The second region AL may correspond (or substantially correspond) to an active region AL (or a channel) of a transistor 100PC. In other words, a portion AL of the semiconductor pattern (SC, AL, DR, and SCL) may be the active region AL of the transistor 100PC, another portion (SC and DR) of the semiconductor pattern (SC, AL, DR, and SCL) may be a source area SC or a drain area DR of the transistor 100PC, and another portion SCL of the semiconductor pattern (SC, AL, DR, and SCL) may be an connection electrode or a connection signal line SCL.

Each of pixels may have an equivalent circuit including a plurality of transistors, at least one capacitor, and at least one light emitting element, and the equivalent circuit of the pixel may be modified in various forms. FIG. 6 illustrates that the pixel includes one transistor 100PC and one light emitting element 100PE, which are included in the pixel.

The source region SC, the active region AL, and the drain region DR of the transistor 100PC may be formed from the semiconductor pattern (SC, AL, DR, and SCL). The source area SC and the drain area DR may extend in directions facing away from each other from the active region AL when viewed in a cross-sectional view. A portion of the connection signal line SCL formed from the semiconductor pattern (SC, AL, DR, and SCL) is illustrated in FIG. 6. According to some embodiments, the connection signal line SCL may be connected to the drain area DR of the transistor 100PC when viewed in a plan view.

A first insulating layer 10 may be located on the buffer layer BFL. The first insulating layer 10 may be overlapped with a plurality of pixels in common to cover the semiconductor pattern (SC, AL, DR, and SCL). The first insulating layer 10 may be an inorganic layer and/or an organic layer and may have a single-layer structure or a multi-layer structure. The first insulating layer 10 may include at least one of an aluminum oxide, a titanium oxide, a silicon oxide, a silicon nitride, a silicon oxynitride, a zirconium oxide, or hafnium oxide. According to some embodiments, the first insulating layer 10 may be a silicon oxide layer in a single-layer structure. An insulating layer of the circuit layer 120, which is to be described in more detail below, as well as the first insulating layer 10, may be an inorganic layer and/or an organic layer, and may have a single-layer structure or a multi-layer structure. The inorganic layer may include at least one of the above-described materials, but embodiments according to the present disclosure are not limited thereto.

The gate GT of the transistor 100PC is located on the first insulating layer 10. The gate GT may be a portion of a metal pattern. The gate GT is overlapped with the active region AL. The gate GT may function as a mask in the process of doping or relatively reducing the semiconductor pattern (SC, AL, DR, and SCL).

A second insulating layer 20 may be located on the first insulating layer 10 to cover the gate GT. The second insulating layer 20 may be overlapped with the pixels in common. The second insulating layer 20 may be an inorganic layer and/or an organic layer and may have a single-layer structure or multi-layer structure. The second insulating layer 20 may include at least one of silicon oxide, silicon nitride, or silicon oxynitride. According to some embodiments, the second insulating layer 20 may have a multi-layer structure including a silicon oxide layer and a silicon nitride layer.

A third insulating layer 30 may be located on the second insulating layer 20. The third insulating layer 30 may have a single-layer or multi-layer structure. For example, the third insulating layer 30 may have a multi-layer structure including a silicon oxide layer and a silicon nitride layer.

A first connection electrode CNE1 may be located on the third insulating layer 30. The first connection electrode CNE1 may be connected with the connection signal line SCL through a contact hole CNT-1 formed through the first, second, and third insulating layers 10, 20, and 30.

A fourth insulating layer 40 may be located on the third insulating layer 30. The fourth insulating layer 40 may be a silicon oxide layer in a single layer. A fifth insulating layer 50 may be located on the fourth insulating layer 40. The fifth insulating layer 50 may be an organic layer.

A second connection electrode CNE2 may be located on the fifth insulating layer 50. The second connection electrode CNE2 may be connected to the first connection electrode CNE1 through a contact hole CNT-2 formed through the fourth insulating layer 40, and the fifth insulating layer 50.

A sixth insulating layer 60 may be located on the fifth insulating layer 50 to cover the second connection electrode CNE2. The sixth insulating layer 60 may be an organic layer.

A light emitting element layer 130 may be located on the circuit layer 120. The light emitting element layer 130 may include a light emitting element 100PE. For example, the light emitting element layer 130 may include an organic light emitting material, an inorganic light emitting material, an organic-inorganic light emitting material, a quantum dot, a quantum rod, a micro-LED, or a nano-LED. The following description will be described while focusing on that the light emitting element 100PE is an organic light emitting element, but embodiments according to the present disclosure are not specifically limited thereto.

The light emitting element 100PE may include a first electrode AE, a light emitting layer EL, and a second electrode CE.

The first electrode AE may be located on the sixth insulating layer 60. The first electrode AE may be connected to the second connection electrode CNE2 through a contact hole CNT-3 formed through the sixth insulating layer 60.

A pixel defining layer 70 may be located on the sixth insulating layer 60 to cover a portion of the first electrode AE. An opening 70-OP is defined in the pixel defining layer 70. The opening 70-OP of the pixel defining layer 70 exposes at least a portion of the first electrode AE.

The first display unit DA1-F (see FIG. 1A) may include an emission region PXA and a non-emission region NPXA adjacent to the emission region PXA. The non-emission region NPXA may surround the light emitting region PXA. According to some embodiments, the emission region PXA is defined to correspond to a partial region of the first electrode AE exposed by the opening 70-OP.

The light emitting layer EL may be located on the first electrode AE. The light emitting layer EL may be located in a region corresponding to the opening 70-OP. Although FIG. 6 illustrates that the light emitting layer EL is located in the opening 70-OP, embodiments according to the present disclosure are not limited thereto. For example, the light emitting layer EL may extend to cover a portion of a side surface of the pixel defining layer 70 and the top surface of the pixel defining layer 70, which define the opening 70-OP.

According to some embodiments of the present disclosure, the light emitting layer EL may be separately formed with respect to each of pixels. When the light emitting layer EL is separately formed in each pixel, each of light emitting layers EL may emit light of at least one of a blue color, a red color, or a green color. However, embodiments according to the present disclosure are not limited thereto. The light emitting layer EL may have an integral form, and may be included in the plurality of pixels in common. In this case, the light emitting layer EL may provide a blue color or may provide a white color.

The second electrode CE may be located on the light emitting layer EL. The second electrode CE may have an integral form and may be included in a plurality of pixels in common.

According to some embodiments of the present disclosure, a hole control layer may be interposed between the first electrode AE and the light emitting layer EL. The hole control layer may be arranged in common in the emission region PXA and the non-emission region NPXA. The hole control layer may include a hole transport layer and may further include a hole injection layer. An electron control layer may be located between the light emitting layer EL and the second electrode CE. The electron control layer may include an electron transport layer and may further include an electron injection layer. The hole control layer and the electron control layer may be formed in the plurality of pixels in common by using an open mask or an ink-jet process.

The encapsulating layer 140 may be located on the light emitting element layer 130. The encapsulating layer 140 may include an inorganic layer, an organic layer, and an inorganic layer sequentially stacked, and layers constituting the encapsulating layer 140 are not limited thereto. The inorganic layers may protect the light emitting element layer 130 from moisture and oxygen, and the organic layer may protect the light emitting element layer 130 from a foreign material such as dust particles. The inorganic layers may include a silicon nitride layer, a silicon oxynitride layer, a silicon oxide layer, a titanium oxide layer, or an aluminum oxide layer. The organic layer may include an acrylic-based organic layer, but embodiments according to the present disclosure are not limited thereto.

The sensor layer 200 may include a base layer 201, a first conductive layer 202, a first insulating layer 203, a second conductive layer 204, and a second insulating layer 205.

The base layer 201 may be an inorganic layer including at least one of silicon nitride, silicon oxynitride, or silicon oxide. Alternatively, the base layer 201 may be an organic layer including an epoxy resin, an acrylic resin, or an imide-based resin. The base layer 201 may have a single-layer structure or a multi-layer structure including layers stacked in the third direction DR3. According to some embodiments of the present disclosure, the sensor layer 200 may not include the base layer 201.

Each of the first conductive layer 202 and the second conductive layer 204 may have a single-layer structure or a multi-layer structure including the layers stacked in the third direction DR3.

Each of the first conductive layer 202 and the second conductive layer 204 having a single-layer structure may include a metal layer or a transparent conductive layer. The metal layer may include molybdenum, silver, titanium, copper, aluminum, or the alloy thereof. The transparent conductive layer may include a transparent conductive oxide such as indium tin oxide (ITO), indium zinc oxide (IZO), zinc oxide (ZnO), or indium zinc tin oxide (IZTO). In addition, the transparent conductive layer may include conductive polymer such as poly(3,4-ethylenedioxythiophene) (PEDOT), metal nanowire, or graphene.

Each of the first conductive layer 202 and the second conductive layer 204 having a multi-layer structure may include metal layers. The metal layers may have, for example, a three-layer structure of titanium/aluminum/titanium. The conductive layer in the multi-layer structure may include at least one metal layer and at least one transparent conductive layer.

According to some embodiments of the present disclosure, the thickness of the first conductive layer 202 may be greater than or equal to the thickness of the second conductive layer 204. When the thickness of the first conductive layer 202 is greater than the thickness of the second conductive layer 204, the resistance of components (e.g., an electrode, a pattern, or a bridge pattern) included in the first conductive layer 202 may be relatively reduced. In addition, because the first conductive layer 202 is located below the second conductive layer 204, even if the thickness of the first conductive layer 202 is increased, the probability that components included in the first conductive layer 202 are viewed by external light reflection, may be lower than that of the second conductive layer 204.

At least one of the first insulating layer 203 or the second insulating layer 205 may include an inorganic film. The inorganic film may include at least one of an aluminum oxide, a titanium oxide, a silicon oxide, a silicon nitride, a silicon oxynitride, a zirconium oxide, or a hafnium oxide.

At least one of the first insulating layer 203 or the second insulating layer 205 may include an organic film. The organic film may include at least one of an acrylic resin, a methacrylic resin, a polyisoprene, a vinyl resin, an epoxy resin, a urethane resin, a cellulose resin, a siloxane resin, a polyimide resin, a polyamide resin, or a perylene resin.

Although the above-description has been made regarding that the sensor layer 200 includes the total of two conductive layers of the first conductive layer 202 and the second conductive layer 204, embodiments according to the present disclosure are not limited thereto. For example, the sensor layer 200 may include at least three conductive layers.

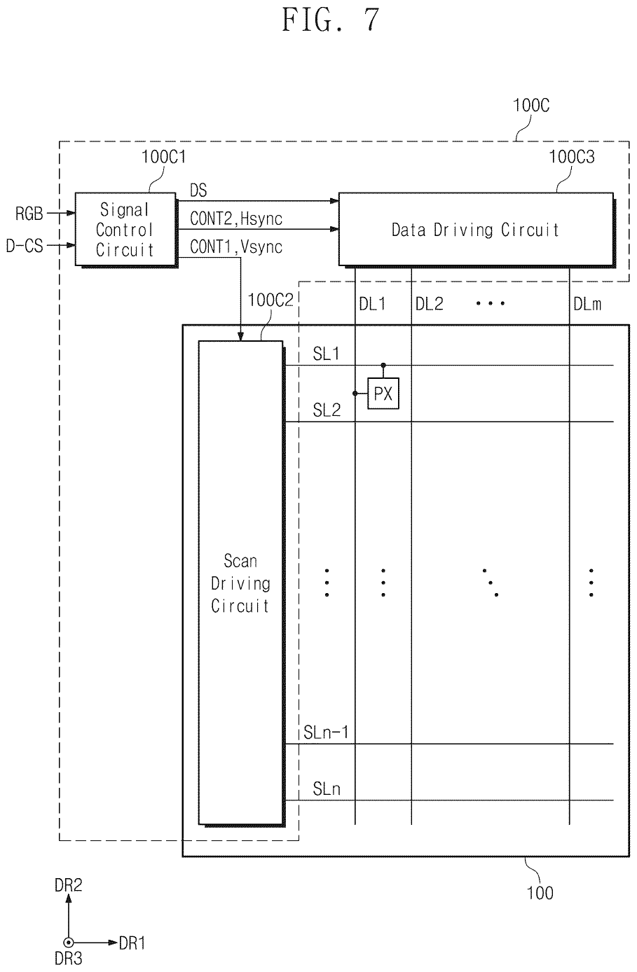

FIG. 7 is a block diagram illustrating the display layer 100 and the display driver 100C According to some embodiments of the present disclosure.

Referring to FIG. 7, the display layer 100 may include a plurality of scan lines SL1, SL2, . . . , SLn-1, and SLn, a plurality of data lines DL1, DL2, . . . , and DLm, and a plurality of pixels PX. Herein, “n” may be an integer equal to or greater than 4, and “m” may be an integer equal to or greater than 3.

Each of the plurality of pixels PX may be connected to a relevant data line among the plurality of data lines DL1 to DLm, and may be connected to a relevant scan line among the plurality of scan lines SL1 to SLn. According to some embodiments of the present disclosure, the display layer 100 may further include light emitting control lines, and the display driver 100C may further include a light emitting driving circuit to provide control signals to the light emitting control lines. A configuration of the display layer 100 is not specifically limited.

Each of the plurality of scan lines SL1 to SLn may extend in the first direction DR1, and the plurality of scan lines SL1 to SLn may be arranged to be spaced from each other in the second direction DR2. Each of the plurality of data lines DL1 to DLm may extend in the second direction DR2, and the plurality of data lines DL1 to DLm may be arranged to be spaced from each other in the first direction DR1.

The display driver 100C may include a signal control circuit 100C1, a scan driving circuit 100C2, and a data driving circuit 100C3.

The signal control circuit 100C1 may receive the image data RGB and a control signal D-CS from the main driver 1000C (see FIG. 2). The control signal D-CS may include various signals. For example, the control signal D-CS may include an input vertical synchronization signal, an input horizontal synchronization signal, a main clock, and a data enable signal.

The signal control circuit 100C1 may generate a first control signal CONT1 and a vertical synchronization signal Vsync based on the control signal D-CS and may output the first control signal CONT1 and the vertical synchronization signal Vsync to the scan driving circuit 100C2.

The signal control circuit 100C1 may generate a second control signal CONT2 and a horizontal synchronization signal Hsync based on the control signal D-CS and may output the second control signal CONT2 and the horizontal synchronization signal Hsync to the data driving circuit 100C3.

In addition, the signal control circuit 100C1 may output, to the data driving circuit 100C3, a driving signal DS which is obtained by processing the image data RGB to be appropriate for an operation condition of the display layer 100. The first control signal CONT1 and the second control signal CONT2 are signals necessary for the operations of the scan driving circuit 100C2 and the data driving circuit 100C3, but embodiments according to the present disclosure are not specially limited thereto.

The scan driving circuit 100C2 may drive the plurality of scan lines SL1 to SLn in response to the first control signal CONT1 and the vertical synchronization signal Vsync. According to some embodiments of the present disclosure, the scan driving circuit 100C2 may be formed in the same process as the circuit layer 120 (see FIG. 6) in the display layer 100, but embodiments according to the present disclosure are not limited thereto. For example, the scan driving circuit 100C2 may be implemented in the form of an integrated circuit (IC) and mounted directly in a specific region of the display layer 100, or mounted in the form of a chip on film (COF) manner on a separate printed circuit board, such that the scan driving circuit 100C2 is electrically connected to the display layer 100.

The data driver circuit 100C3 may output grayscale voltages to the plurality of data lines DL1 to DLm in response to the second control signal CONT2, the horizontal synchronization signal Hsync, and the driving signal DS from the signal control circuit 100C1. The data driving circuit 100C3 may be implemented in the form of an integrated circuit to be directly mounted in a specific region of the display layer 100 or be mounted on a separate printed circuit board in a chip on film manner, such that the data driving circuit 100C3 is electrically connected to the display layer 100, but embodiments according to the present disclosure are not limited thereto. For example, the data driving circuit 100C3 may be formed in the same process as the circuit layer 120 (see FIG. 6) in the display layer 100.

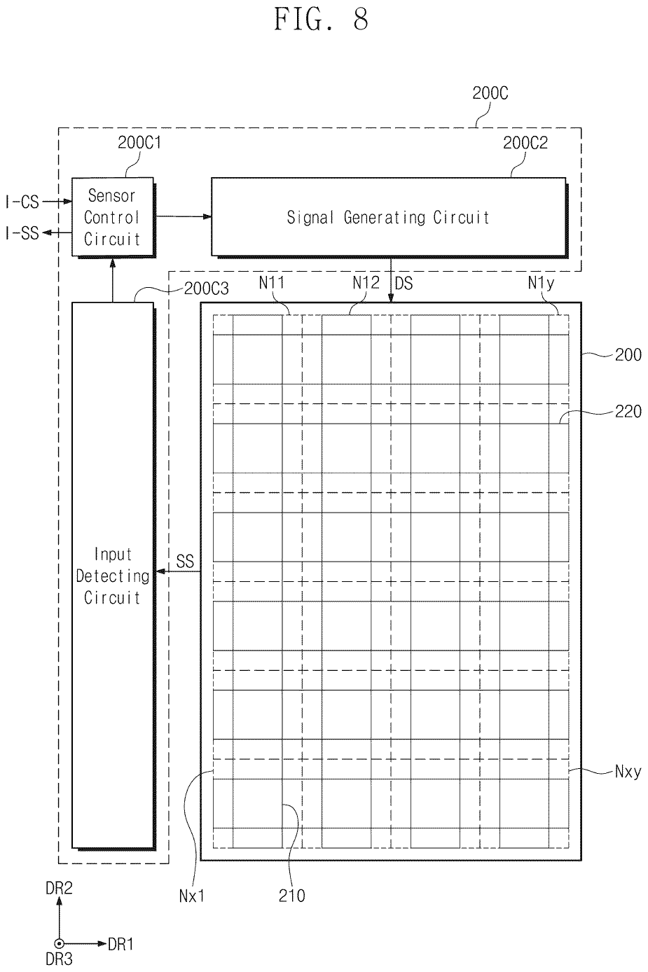

FIG. 8 is a block diagram illustrating the sensor layer 200 and the sensor driver 200C according to some embodiments of the present disclosure.

Referring to FIG. 8, the sensor layer 200 may include a plurality of first electrodes 210 and a plurality of second electrodes 220. The plurality of first electrodes 210 may be arranged in the first direction DR1, and each first electrode 210 may extend in the second direction DR2. The plurality of second electrodes 220 may be arranged in the second direction DR2, and each second electrode 220 may extend in the first direction DR1. The plurality of second electrodes 210 may cross the plurality of first electrodes 220. The sensor layer 200 may further include a plurality of signal lines connected to the plurality of first electrodes 210 and the plurality of second electrodes 220.

The scan driver 200C may receive a control signal I-CS from the main driver 1000C (see FIG. 2) and may provide a coordinate signal I-SS to the main driver 1000C (see FIG. 2).

For example, the sensor driver 200C may be implemented in the form of an integrated circuit (IC) and mounted directly in a specific region of the sensor layer 200, or mounted in the form of a chip on film (COF) manner on a separate printed circuit board, such that the sensor driver 200C is electrically connected to the sensor layer 200.

The sensor driver 200C may include a sensor control circuit 200C1, a signal generating circuit 200C2, and an input detecting circuit 200C3. The sensor control circuit 200C1 may control operations of the signal generating circuit 200C2, and the input detecting circuit 200C3 based on the control signal I-CS.

The sensor driver 200C may be selectively driven in the first mode for sensing the passive input or the second mode for sensing the active input.

In the first mode, the signal generating circuit 200C2 may sequentially output the driving signal DS to the sensor layer 200, for example, the first electrodes 210. The input detecting circuit 200C3 may receive sensing signals SS from the sensor layer 200. For example, the input detecting circuit 200C3 may receive sensing signals SS from the second electrodes 220. According to some embodiments of the present disclosure, the signal generating circuit 200C2 may sequentially output the driving signal DS to the second electrodes 220, and the input detecting circuit 200C3 may receive the sensing signals SS from the first electrodes 210.

In the second mode, the input detecting circuit 200C3 may receive the sensing signals SS from the first electrodes 210 and the second electrodes 220. According to some embodiments of the present disclosure, in the second mode, the sensor layer 200 may output a first signal received from the outside and may output a second signal received from the outside and different from the first signal. The first signal and the second signal may be used to calculate the position of a pen tip. The first signal and the second signal may be a first voltage signal and a second voltage signal described with reference to FIGS. 14 to 17. In addition, in the second mode, the sensor layer 200 may output a third signal received from the outside. The third signal may be used to correct the position of a pen tip. The third signal may be a third voltage signal described with reference to FIGS. 14 to 17.

FIG. 8 illustrates nodes N11 to Nxy. Each of the nodes N11 to Nxy may be defined in a region in which one first electrode 210 of the plurality of first electrodes 210 crosses one second electrode 220 of the plurality of second electrodes 220. FIG. 8 illustrates four nodes N11, N12, . . . , and N1y arranged in the first direction DR2 and six nodes N11 to Nx1 arranged in the second direction DR2. However, the number of the nodes N11 to Nxy is not limited thereto, but may be smaller than or larger than the number of the nodes N11 to Nxy illustrated in FIG. 6.

FIG. 9 is a plan view illustrating one node SN according to some embodiments of the present disclosure.

Referring to FIGS. 8 and 9, one node SN may be one of nodes N11 to Nxy. FIG. 9 illustrates a portion of one first electrode 210 and a portion of one second electrode 220 overlapped with one node SN. The form of the first electrode 210 and the second electrode 220 illustrated in FIG. 9 is provided only for the illustrative purpose, and may be variously changed.

The first electrode 210 may include a plurality of divided electrodes 210dv1, 210dv2, and 210dv3 spaced apart from each other in the first direction DR1. Each of the divided electrodes 210dv1, 210dv2, and 210dv3 may extend in the second direction DR2. The divided electrodes 210dv1, 210dv2, and 210dv3 are connected to one trace line to form one channel.

The second electrode 220 may include a plurality of patterns 221 and a plurality of bridge patterns 222 electrically connected to the patterns 221. The bridge patterns 222 may be insulated from the divided electrodes 210dv1, 210dv2, and 210dv3 while crossing the divided electrodes 210dv1, 210dv2, and 210dv3. For example, the bridge patterns 222 may be included in the first conductive layer 202 described with reference to FIG. 6, and the patterns 221 and the divided electrodes 210dv1, 210dv2, and 210dv3 may be included in the second conductive layer 204 described with reference to FIG. 6.

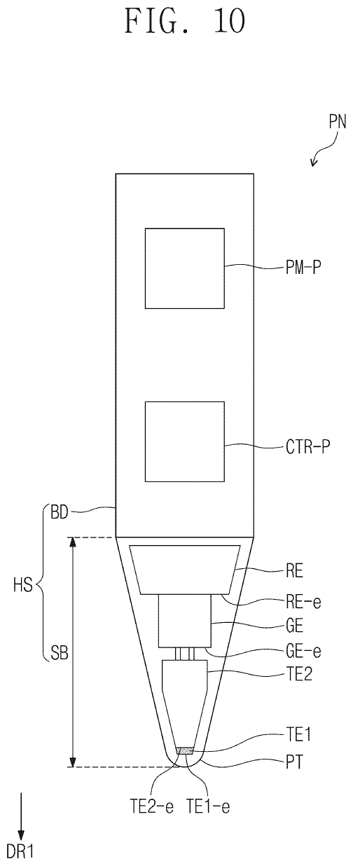

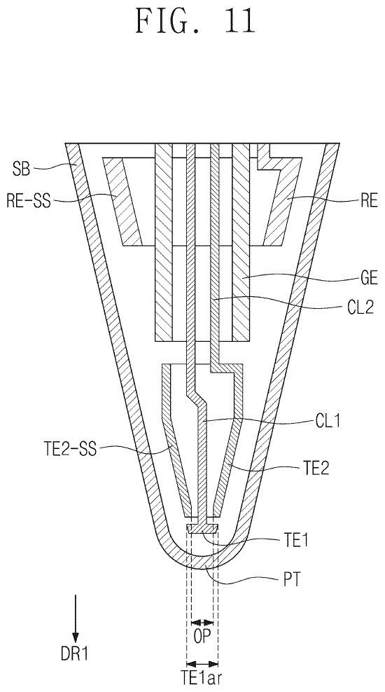

FIG. 10 is a block diagram schematically illustrating the input device PN according to some embodiments of the present disclosure. FIG. 11 is a cross-sectional view of a portion of the input device PN according to some embodiments of the present disclosure.

Referring to FIGS. 5, 10, and 11, the input device PN may include a housing HS, a power supply PM-P, a controller CTR-P, and a plurality of electrodes RE, GE, TE1, and TE2. However, components constituting the input device PN are not limited to the above-listed components. For example, the input device PN may further include a transmitter, a receiver, an electrode switch to switch a signal transmitting mode or a signal receiving mode, a pressure sensor to sense pressure, a memory to store specific information, or a rotating sensor to sense rotation.

The housing HS may have the form of a pen, and a receiving space may be defined inside the housing HS. The power supply PM-P, the controller CTR-P, and the plurality of electrodes RE, GE, TE1, and TE2 may be received in the receiving space defined inside the housing HS.

The housing HS may include a body portion BD and a tapered portion SB which is adjacent to the body portion BD in the first direction DR1 and includes a pen tip PT. The body portion BD may have the shape of a cylinder and may be gripped by a user. However, the shape of the body portion BD is provided only for the illustrative purpose, and may be variously changed. For example, the shape of the body portion BD may be variously changed to, for example, the shape of a square column, a triangular column, a pentagonal column, or a hexagonal column. The tapered portion SB may have the shape of a cone extending from the body portion BD and gradually narrowed toward the pen tip PT. However, the shape of the tapered portion SB may be variously changed. The tapered portion SB may be referred to as an inclined portion SB.

The power supply PM-P may supply power to the controller CTR-P and the electrodes RE, GE, TE1, and TE2 provided in the input device PN. The power supply PM-P may include a battery or a capacitor having a higher capacity.

The controller CTR-P may control the operation of the input device PN. The controller CTR-P may be an application-specific integrated circuit (ASIC). The controller CTR-P may be configured to operate based on designed program.

The electrodes RE, GE, TE1, and TE2 may include a first tip electrode TE1, a second tip electrode TE2, a ground electrode GE, and a ring electrode RE. However, components constituting the electrodes RE, GE, TE1, and TE2 are not limited to the above-listed components. For example, the ground electrode GE may be omitted.

An end RE-e of the ring electrode RE, an end GE-e of the ground electrode GE, an end TE2-e of the second tip electrode TE2, and an end TE1-e of the first tip electrode TE1 may be sequentially spaced apart from the body portion BD in the first direction DR1.

The sensor driver 200C may calculate and correct coordinates using a signal received from the ring electrode RE and a signal received from the first and second tip electrodes TE1 and TE2. When the input device PN is tilted with respect to a plane parallel to the sensor layer 200, the tapered portion SB faces the sensor layer 200, and even a side portion of the first tip electrode TE1 and a tapered surface of the second tip electrode TE2 face the sensor layer 200. Accordingly, the intensity of the signal may be increased in a direction in which the input device PN is titled. In this case, the coordinates (or coordinates of a position inside the sensor layer 200), which are calculated by using the signal received from the first and second tip electrodes TE1 and TE2, may correspond to a point shifted from a contact point between the input device PN and the electronic device 1000 in the direction in which the input device PN is titled. The sensor driver 200C may acquire coordinates (or the coordinates of the position inside the sensor layer 200) corresponding to a real contact position by correcting the coordinates of the first and second tip electrodes TE1 and TE2, based on information (for example, coordinates) acquired from the ring electrode RE. The coordinates corresponding to the real contact point may correspond to the position of the pen tip PT.

The ground electrode GE may be interposed between the first and second tip electrodes TE1 and TE2, and the ring electrode RE. The ground electrode GE may be grounded or may receive a specific constant voltage. As the signal received from the first and second tip electrodes TE1 and TE2 and the signal received from the ring electrode RE may be definitely distinguished from each other by the ground electrode GE, the precision of coordinates calculated using the signals may be relatively improved.

The first tip electrode TE1 may face the pen tip PT in the first direction DR1. One surface of the first tip electrode TE1 facing the pen tip PT is a flat for the illustrative purpose, but embodiments according to the present disclosure are not limited thereto. For example, the first tip electrode TE1 may have the shape convexly protruding corresponding to the shape of the pen tip PT.

The input device PN may further include a first connection line CL1 located inside the housing HS. The first connection line CL1 may be connected to the first tip electrode TE1 while extending from the body portion BD toward the pen tip PT of the tapered portion SB.

The second tip electrode TE2 may surround the first connection line CL1. The area of the second tip electrode TE2 may be less than the area of the first tip electrode TE1. For example, the area of the second tip electrode TE2 may be an area of a bent outer surface, which faces the housing HS, of the second tip electrode T2, and the area of the first tip electrode TE1 may be an area of one flat surface facing the pen tip PT.

The second tip electrode TE2 may have an opening OP defined therein such that the first connection line CL1 passes through the opening OP. The input device PN may further include a second connection line CL2 located inside the housing HS. The second connection line CL2 may be connected to the second tip electrode TE2 while extending from the body portion BD toward the tapered portion SB.

The first tip electrode TE1 may be arranged to face the opening OP of the second tip electrode TE2. When viewed in the first direction DR1, an area TE1ar of the first tip electrode TE1 may be greater than a size of the opening OP. However, this is provided only for the illustrative purpose, and embodiments according to the present disclosure are not limited thereto.

The ground electrode GE may surround the first connection line CL1 and the second connection line CL2. The ring electrode RE may surround the ground electrode GE. In other words, the ground electrode GE may be interposed between the first and second connection lines CL1 and CL2, and the ring electrode RE. Accordingly, the ground electrode GE may shield signals provided to the first and second connection lines CL1 and CL2 and a signal in the ring electrode RE.

Each of the second tip electrode TE2 and the ring electrode RE may have a tapered surface inclined with respect to the first direction DR1. For example, a tapered surface TE2-SS of the second tip electrode TE2 and a tapered surface RE-SS of the ring electrode RE may face the tapered portion SB of the housing HS.

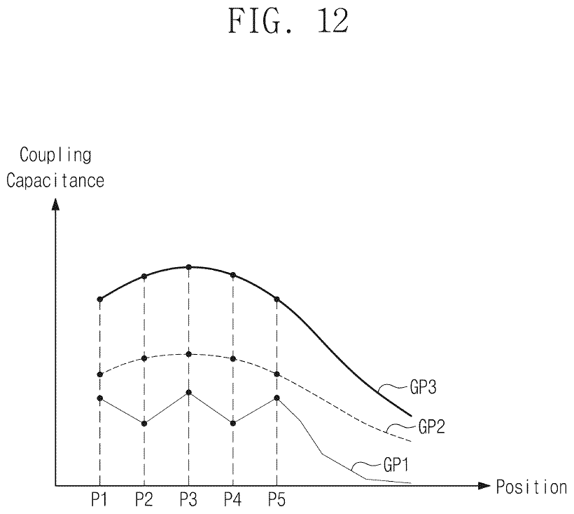

FIG. 12 illustrates graphs representing a coupling capacitance as a function of a position of the input device PN (see FIG. 10) according to some embodiments of the present disclosure.

Referring to FIGS. 9, 10, and 12, a first graph GP1 represents a first coupling capacitance between the first tip electrode TE1 and the first electrode 210 as a function of the position of the input device PN, and a second graph GP2 represents a second coupling capacitance between the second tip electrode TE2 and the first electrode 210 as a function of the position of the input device PN. A third graph GP3 is a graph showing a value derived by merging the first coupling capacitance and the second coupling capacitance.

As describe above with reference to FIG. 4, when the distance between the highest surface of the window module 300 and the sensor layer 200 is equal to or greater than a specific distance, the difference in distance between the input device PN and each of specific points of the first electrode 210 may be equal to or greater than a specific level. In this case, the signal received from the input device PN may be more uniformly transmitted to the sensor layer 200. Accordingly, a curve of the signal from the sensor layer 200 may have the form of a normalized distribution. When the form of the signal has the form of the normalized distribution, the precision of the calculation of coordinates may be relatively improved.

As the electronic device 1000 is implemented in a slimmer shape, and the distance between the highest surface of the window module 300 and the sensor layer 200 is relatively reduced, the difference in distance between the input device PN and each of specific points inside the first electrode 210 may exceed a specific level. In this case, when the pen tip PT directly faces the pattern of the first electrode 210, a stronger signal may be transmitted. When the pen tip PT faces a space between patterns, a weaker signal (or a lower signal) may be provided. In other words, the signal received from the input device PN may be distorted depending on the shape of the first electrode 210.

According to some embodiments of the present disclosure, the tip electrode of the input device PN may be divided into at least two tip electrodes. For example, the input device PN may include the first tip electrode TE1 and the second tip electrode TE2. Accordingly, the sensor layer 200 may receive the signal provided from the first tip electrode TE1 and the signal provided from the second tip electrode TE2. In this case, the distortion of the signal provided from the input device PN may be relatively reduced or minimized depending on the shape of the first electrode 210. Accordingly, the precision of the coordinates may be relatively improved.

The first tip electrode TE1 may be located to be closer to the pen tip PT, than the second tip electrode TE2. Accordingly, the difference in distance between the first tip electrode TE1 and each of the specific points inside the first electrode 210 may be greater than the difference in distance between the second tip electrode TE2 and each of the specific points inside the first electrode 210. FIG. 9 illustrates that five points P1, P2, P3, P4, and P5 are provided in the first electrode 210. The first, third, and fifth points P1, P3, and P5 are points overlapped with the divided electrodes 210dv1, 210dv2, and 210dv3, and the second and fourth points P2 and P4 are points overlapped with the regions among the divided electrodes 210dv1, 210dv2, and 210dv3.

Referring to the first graph GP1, it may be recognized that the first coupling capacitance between the first tip electrode TE1 and the first electrode 210 may be measured as a greater value when the input device PN is positioned at the first, third, and fifth points P1, P3, and P5, as compared to when the input device PN is positioned at the second and fourth points P2 and P4.

Referring to the second graph GP2, it may be recognized that the second coupling capacitance between the second tip electrode TE2 and the first electrode 210 is greatest when the input device PN is positioned at the third point P3 facing the center of the first electrode 210, and may decrease, as the input device PN is farther away from the center of the first electrode 210. The first coupling capacitance and the second coupling capacitance may correspond to the intensity of a signal.

According to some embodiments of the present disclosure, the sensor driver 200C may calculate the signal received from the first tip electrode TE1 and the signal received from the second tip electrode TE2 to derive the result as shown in a third graph GP3. The calculation may be performed by adding the signal received from the first tip electrode TE1 to the signal received from the second tip electrode TE2, or by applying different weights to the signal received from the first tip electrode TE1 and the signal received from the second tip electrode TE2 and adding the results. However, this is provided only for the illustrative purpose, and embodiments according to the present disclosure are not limited thereto.

According to some embodiments of the present disclosure, the sensor driver 200C may calculate (or detect) a position of the pen tip PT, based on the signal received from the first tip electrode TE1 and the signal received from the second tip electrode TE2. The position of the pen tip PT may correspond to the position inside the sensor layer 200, which corresponds to the input made by the input device PN, or correspond to coordinates of the input device PN. Even if the signal received from the first tip electrode TE1 is distorted depending on the shape of an electrode inside the sensor layer 200, the sensor driver 200C calculates the coordinates (or the position) using the signals received from the first tip electrode TE1 and the second tip electrode TE2. Accordingly, the precision of the coordinates may be relatively improved.

FIG. 13 is a view illustrating the input device PN according to some embodiments of the present disclosure. FIG. 14 is a view illustrating voltage signals provided to a first tip electrode, a second tip electrode, and a ring electrode according to some embodiments of the present disclosure.

Referring to FIGS. 5, 10, 13, and 14, the power supply PM-P may include a plurality of voltage sources PM1, PM2, and PM3. The plurality of voltage sources PM1, PM2, and PM3 may include the first voltage source PM1, the second voltage source PM2, and the third voltage source PM3. Each of the first voltage source PM1, the second voltage source PM2, and the third voltage source PM3 may be an alternating current (AC) voltage source. The first voltage source PM1 may provide a first voltage signal VTE1, the second voltage source PM2 may provide the second voltage signal VTE2, and the third voltage source PM3 may provide the third voltage signal VRE. Accordingly, each of the first voltage signal VTE1, the second voltage signal VTE2, and the third voltage signal VRE may be an AC signal. The first voltage signal VTE1, the second voltage signal VTE2, and the third voltage signal VRE may be referred to as a first signal, a second signal, and a third signal, respectively.

The first voltage source PM1 may provide a first voltage signal VTE1 to the first tip electrode TE1, the second voltage source PM2 may provide the second voltage signal VTE2 to the second tip electrode TE2, and the third voltage source PM3 may provide the third voltage signal VRE to the ring electrode RE. The ground electrode GE may be grounded.

According to some embodiments of the present disclosure, the first voltage signal VTE1 may have a frequency equal to a frequency of the second voltage signal VTE2. In addition, the first voltage signal VTE1 and the second voltage signal VTE2 may be in phase. In this case, the sensor driver 200C may receive one signal obtained by combining the first voltage signal VTE1 provided from the first tip electrode TE1 and the second voltage signal VTE2 provided from the second tip electrode TE2. Accordingly, the operation for calculating the position of an input, which is made by the input device PN, inside the sensor layer 200, or the position of the pen tip PT of the input device PN, may be simplified.

The first voltage signal VTE1 may have an amplitude (or magnitude or intensity) different from an amplitude (or magnitude or intensity) of the second voltage signal VTE2. As illustrated in FIG. 14, the amplitude of the first voltage signal VTE1 is less than the amplitude of the second voltage signal VTE2 by way of example. In this case, the intensity of the first signal output from the first tip electrode TE1, which is relatively significantly affected by the shape of the electrode of the sensor layer 200, may be relatively reduced. In other words, the intensity of the first signal output from the first tip electrode TE1 may be lower than the intensity of the second signal output from the second tip electrode TE2. Accordingly, the precision of the coordinates obtained by the sensor layer 200 may be relatively improved.

The amplitude of the first voltage signal VTE1 and the amplitude of the second voltage signal VTE2 may be variously applied. For example, the amplitude of the first voltage signal VTE1 and the amplitude of the second voltage signal VTE2 may be changed depending on various scenarios. The scenario may be recognized autonomously by the input device PN or received from the sensor driver 200C or the electronic device 1000. Hereinafter, the description about four scenarios will be made by way of example.

The first scenario is the case that at least a specific distance is ensured between the input device PN and the sensor layer 200. In this case, the variation of distances between a plurality of points is not great in an overlap region between the first tip electrode TE1 and one electrode. For example, the amplitude of the first voltage signal VTE1 and the amplitude of the second voltage signal VTE2 may be equal to each other. When the at least a specific distance is ensured, the input device PN may make an input without being in contact with the electronic device 1000 (hereinafter, a hover state). Alternatively, as described with reference to FIG. 4, the distance between the highest surface of the window module 300 and the sensor layer 200 may be ensured to at least a specific distance.

In addition, the amplitude of the first voltage signal VTE1 and the amplitude of the second voltage signal VTE2 may be adjusted, depending on the tilting angle made between the sensor layer 200 and the input device PN. For example, the second scenario may be the case that the input device PN is positioned perpendicularly to the sensor layer 200. In this case, the variation of a signal transmitted depending on the shape of the electrode may be less made in the second tip electrode TE2 rather than the first tip electrode TE1. Accordingly, as illustrated in FIG. 14, the amplitude of the first voltage signal VTE1 may be less than the amplitude of the second voltage signal VTE2. The third scenario may be the case that the input device PN is tilted. In this case, the variation of the signal transmitted may be made depending on the shape of the electrode even in the second tip electrode TE2. Accordingly, the difference between the amplitude of the first voltage signal VTE1 and the amplitude of the second voltage signal VTE2 may be adjusted to be relatively reduced, as compared to the case that the input device PN is positioned perpendicularly to the sensor layer 200.

Accordingly, the amplitude of the first voltage signal VTE1 and the amplitude of the second voltage signal VTE2 may be adjusted depending on a signal to noise ratio required. For example, the fourth scenario may be the case that the signal to noise ratio is insufficient. In this case, to increase the signal to noise ratio, at least one of the amplitude of the first voltage signal VTE1 or the amplitude of the second voltage signal VTE2, for example, both of the amplitude of the first voltage signal VTE1 and the amplitude of the second voltage signal VTE2 may be increased.

The third voltage signal VRE may be a signal distinguished from the first and second voltage signals VTE1 and VTE2. Accordingly, the amplitude, phase, and magnitude of the third voltage signal VRE may be determined regardless of the amplitudes, phases, and magnitudes of the first and second voltage signals VTE1 and VTE2.

FIG. 15 is a view illustrating voltage signals provided to a first tip electrode, a second tip electrode, and a ring electrode according to some embodiments of the present disclosure.

Accordingly, as illustrated in FIGS. 5, 13, and 15, a first voltage signal VTE1a may have a frequency equal to the frequency of the second voltage signal VTE2. For example, the first voltage signal VTE1a and the second voltage signal VTE2 may be in phase. In this case, the sensor driver 200C may receive one signal obtained by combining the first voltage signal VTE1a, which is provided from the first tip electrode TE1, and the second voltage signal VTE2 provided from the second tip electrode TE2. Accordingly, the operation for calculating the position of an input, which is made by the input device PN, inside the sensor layer 200, or the position of the pen tip PT of the input device PN, may be simplified.

A time period for providing the first voltage signal VTE1a may be shorter than a time period for providing the second voltage signal VTE2, within the same time duration. In other words, the number of times of outputting the first voltage signal VTE1a may be smaller than the number of times of outputting the second voltage signal VTE2. In this case, the amplitude (or the size or the intensity) of the first voltage signal VTE1a may be equal to an amplitude (or magnitude or intensity) equal to an amplitude (or magnitude or intensity) of the second voltage signal VTE2. However, embodiments according to the present disclosure are not limited thereto. The amplitude of the first voltage signal VTE1a may be adjusted to be less than the amplitude of the second voltage signal VTE2.

For example, the number of times of outputting the first voltage signal VTE1a and the number of times of outputting the second voltage signal VTE2 may be changed depending on various scenarios. The scenario may be recognized autonomously by the input device PN or received from the sensor driver 200C or the electronic device 1000. The scenario may be understood based on the four scenarios described with reference to FIG. 14, and the amplitude increased may be understood corresponding to the number of output times increased.

The sensor layer 200 may output the first voltage signal VTE1a and the second voltage signal VTE2 which are received. The sensor driver 200C may be configured to receive the first voltage signal VTE1a and the second voltage signal VTE2 provided from the sensor layer 200 and calculate information about the position of the pen tip, based on the received voltage signals. The main driver 1000C may be configured to control the operation of the display driver 100C based on a coordinate signal provided from the sensor driver 200C.

Each of the first voltage signal VTE1a and the second voltage signal VTE2 is an AC signal, and a length of a duration in which the first voltage signal VTE1a has a waveform may be shorter than a length of a duration in which the second voltage signal VTE2 has a waveform. The sensor driver 200C may be configured to generate a coordinate signal, based on information obtained by summing the first voltage signal VTE1a and the second voltage signal VTE2.

FIG. 16 is a view illustrating voltage signals provided to a first tip electrode, a second tip electrode, and a ring electrode according to some embodiments of the present disclosure.

Referring to FIGS. 5, 13, and 16, the controller CTR-P may be configured to provide a first voltage signal VTE1b to the first tip electrode TE1, provide the second voltage signal VTE2 to the second tip electrode TE2, and provide the third voltage signal VRE to the ring electrode RE. The ground electrode GE may be grounded.

The controller CTR-P may be configured to individually control a frequency, an amplitude, a phase, and an output timing of a signal transmitted to the first tip electrode TE1 and a frequency, an amplitude, a phase, and an output timing of a signal transmitted to the second tip electrode TE2. Accordingly, each of the first voltage signal VTE1b, the second voltage signal VTE2, and the third voltage signal VRE may be individually provided. The controller CTR-P may be configured to individually control a frequency, an amplitude, a phase, and an output timing of the first voltage signal VTE1b and a frequency, an amplitude, a phase, and an output timing of the second voltage signal VTE2. In this case, the sensor driver 200C may separate the first voltage signal VTE1b received from the first tip electrode TE1 from the second voltage signal VTE2 received from the second tip electrode TE2, and may individually process the first voltage signal VTE1b and the second voltage signal VTE2. Although the complexity of the computation increases, the sensor driver 200C may process various algorithms using two signals of the first voltage signal VTE1b and the second voltage signal VTE2.

FIG. 17 is a view illustrating voltage signals provided to a first tip electrode, a second tip electrode, and a ring electrode according to some embodiments of the present disclosure.

Referring to FIGS. 13 and 17, an amplitude of a signal provided from at least one of the first voltage source PM1 or the second voltage source PM2 may be ‘0’ V. In other words, a DC signal may be provided. Accordingly, any one of a first voltage signal VTE1c, and the second voltage signal VTE2 may be an AC signal, and a remaining one of the first voltage signal VTE1c and the second voltage signal VTE2 may be a DC signal.

According to some embodiments of the present disclosure, the first voltage signal VTE1c provided to the first tip electrode TE1 may be a DC signal, and the second voltage signal VTE2 provided to the second tip electrode TE2 may be an AC signal. For example, the position of the input inside the sensor layer 200 by the input device PN or the position of the pen tip PT of the input device PN may be calculated by using only the second voltage signal VTE2 provided to the second tip electrode TE2, as the first voltage signal VTE1c is grounded.

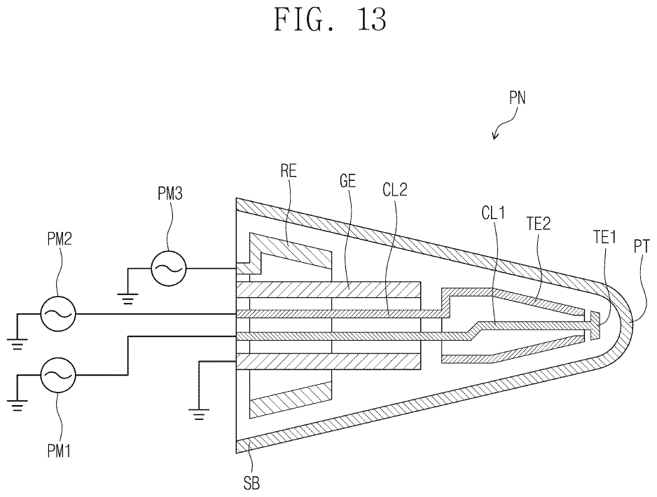

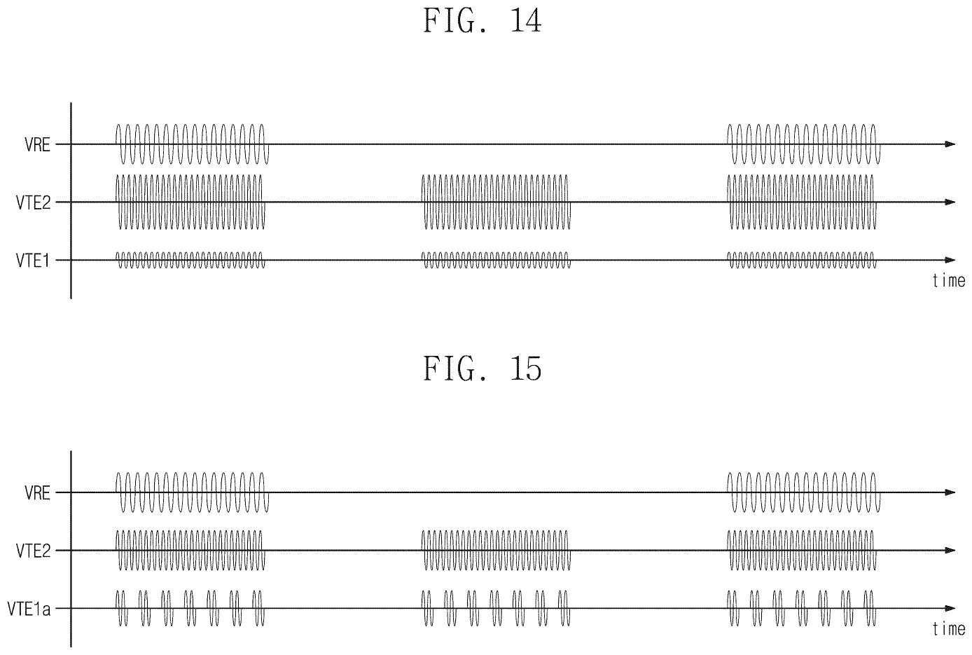

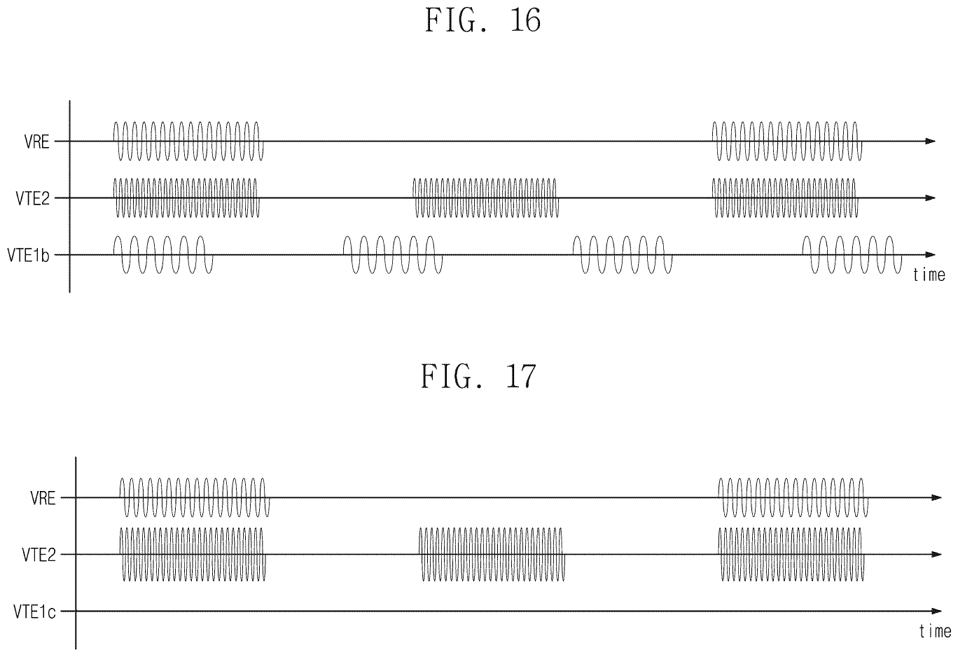

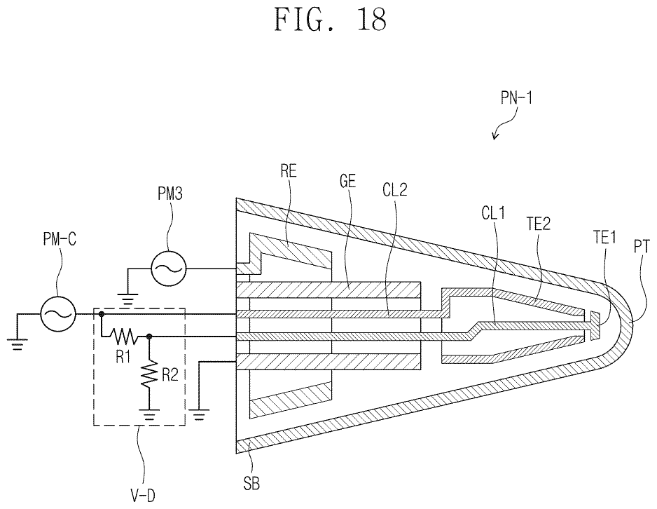

FIG. 18 is a view illustrating an input device PN-1 according to some embodiments of the present disclosure. In the following description made with reference to FIG. 18, the same components as the components described with reference to FIG. 13 will be assigned with the same reference numerals, and some repetitive details thereof may be omitted to avoid redundancy.

Referring to FIGS. 10 and 18, the input device PN-1 may include a voltage source PM-C and a voltage division circuit V-D located in the housing HS.

The voltage source PM-C may be configured to provide the second voltage signal VTE2 (see FIG. 14) to the first tip electrode TE1 and the second tip electrode TE2. Hereinafter, the second voltage signal VTE2 is referred to as a tip voltage signal VTE2. The signal provided from the voltage source PM-C may be transmitted to the first tip electrode TE1 and the second tip electrode TE2.

The voltage division circuit V-D may be connected between the voltage source PM-C and the first connection line CL1. The voltage division circuit V-D may include a first resistor R1 connected between the voltage source PM-C and the first connection line CL1 and a second resistor R2 connected to a node between the first resistor R1 and the first connection line CL1. Another terminal of the second resistor R2 may be grounded.

Referring to FIG. 14 together, the tip voltage signal VTE2 may be output from the voltage source PM-C. The tip voltage signal VTE2 may be transmitted to the second tip electrode TE2. The tip voltage signal VTE2 may be transmitted to the first tip electrode TE1 through the voltage division circuit V-D. The signal transmitted to the first tip electrode TE1 may be similar to the first voltage signal VTE1 illustrated in FIG. 14.

According to some embodiments of the present disclosure, an amplitude (or a magnitude or intensity) of a signal transmitted to the first tip electrode TE1 may be less than an amplitude (or a magnitude de or intensity) of a signal transmitted to the second tip electrode TE2, using the voltage division circuit V-D.

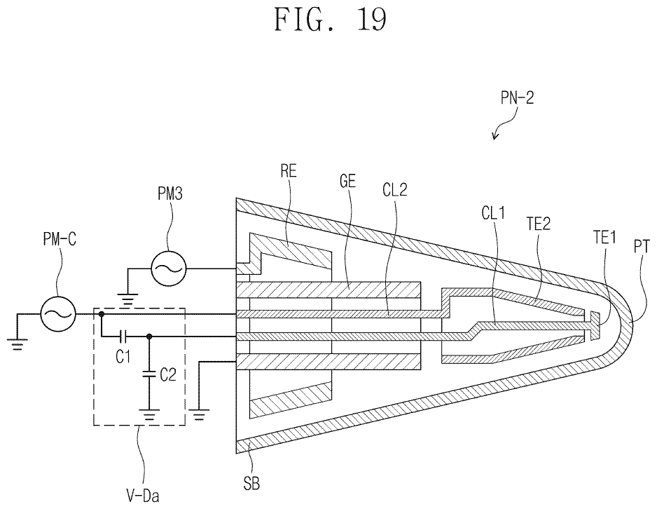

FIG. 19 is a view illustrating an input device PN-2 according to some embodiments of the present disclosure. In the following description made with reference to FIG. 19, the same components as the components described with reference to FIG. 13 will be assigned with the same reference numerals, and some repetitive details thereof may be omitted to avoid redundancy.

Referring to FIGS. 10 and 19, the input device PN-2 may include the voltage source PM-C and a voltage division circuit V-Da located in the housing HS.

The voltage division circuit V-Da may be connected between the voltage source PM-C and the first connection line CL1. The voltage division circuit V-Da may include a first capacitor C1, which is connected between the voltage source PM-C and the first connection line CL1, and a second capacitor C2 which is connected to a node between the first capacitor C1 and the first connection line CL1. Another terminal of a second capacitor C2 may be grounded.

According to some embodiments of the present disclosure, an amplitude (or a magnitude or intensity) of a signal transmitted to the first tip electrode TE1 may be less than an amplitude (or a magnitude de or intensity) of a signal transmitted to the second tip electrode TE2, using the voltage division circuit V-Da.

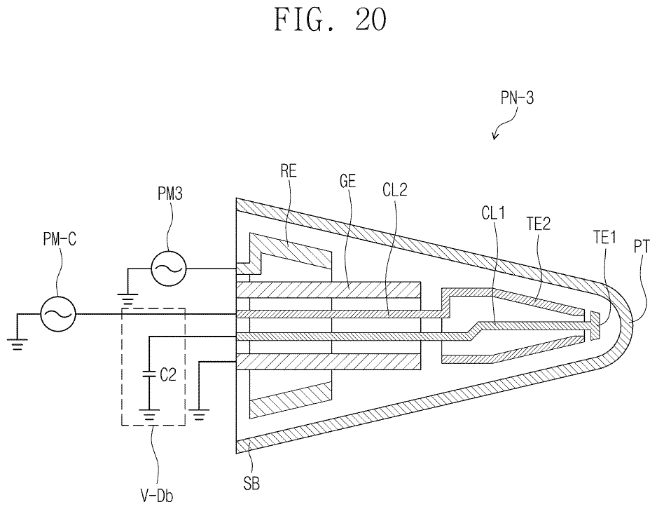

FIG. 20 is a view illustrating an input device PN-3 according to some embodiments of the present disclosure. The following description will be made with reference to FIG. 20 while focusing on the difference from the input device PN-2 described with reference to FIG. 19.

Referring to FIGS. 10 and 20, the input device PN-3 may include the voltage source PM-C and a voltage division circuit V-Db located in the housing HS.

The voltage division circuit V-Db may include the second capacitor C2 connected between the first connection line CL1 and the ground terminal. The first capacitor C1 illustrated in FIG. 19 may be omitted. In this case, a coupling capacitor formed between the first connection line CL1 and the second connection line CL2 may function as the first capacitor C1.

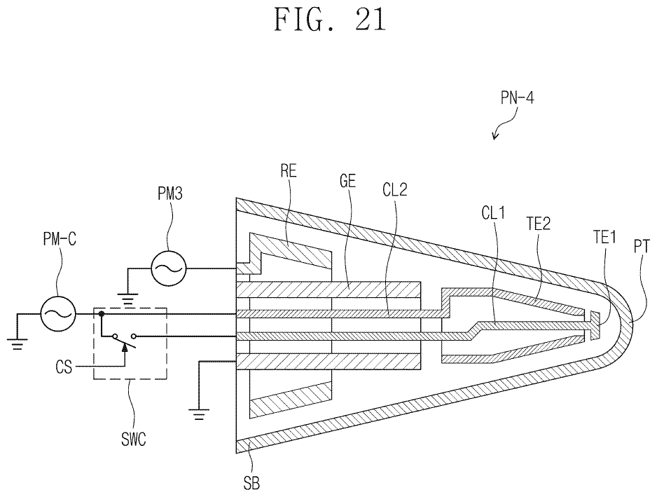

FIG. 21 is a view illustrating an input device PN-4 according to some embodiments of the present disclosure. In the following description made with reference to FIG. 21, the same components as the components described with reference to FIG. 13 will be assigned with the same reference numerals, and some repetitive details thereof may be omitted to avoid redundancy.

Referring to FIGS. 10 and 21, the input device PN-4 may include a voltage source PM-C and a switching circuit SWC located in the housing HS.

The voltage source PM-C may be configured to provide the second voltage signal VTE2 (see FIG. 15) to the first tip electrode TE1 and the second tip electrode TE2. Hereinafter, the second voltage signal VTE2 is referred to as the tip voltage signal VTE2. The signal provided from the voltage source PM-C may be transmitted to the first tip electrode TE1 and the second tip electrode TE2.

The switching circuit SWC may be connected between the voltage source PM-C and the first connection line CL1. The switching circuit SWC may be turned on or off to transmit the tip voltage signal VTE2 to the first tip electrode TE1 or not.

The switching circuit SWC may be controlled through the control signal CS. The control signal CS may be a signal determined depending on a use condition or a user state of the input device PN-4. For example, the switching circuit SWC may have an on-off timing variously changed depending on a scenario. The scenario may be recognized autonomously by the input device PN-4 or received from the sensor driver 200C or the electronic device 1000. The scenario may be understood based on the four scenarios described with reference to FIG. 14, and the amplitude increased may be understood corresponding to that the number of times of turning on the switching circuit SWC and the period for turning on the switching circuit SWC are increased.

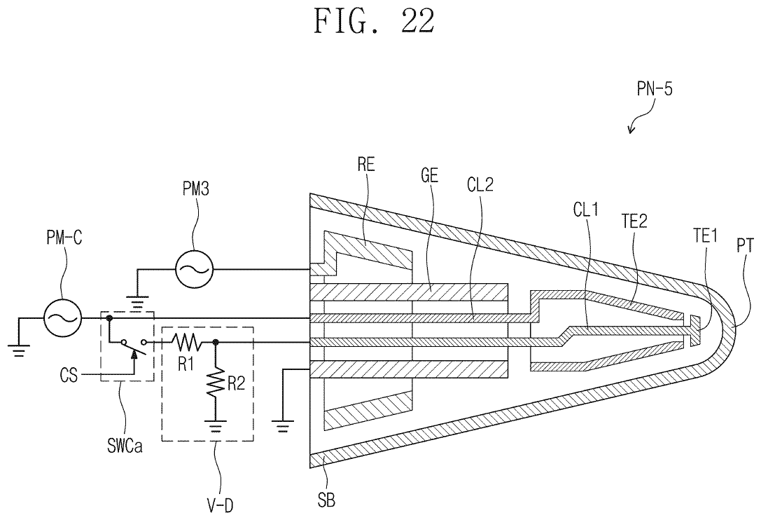

FIG. 22 is a view illustrating an input device PN-5 according to some embodiments of the present disclosure. In the following description made with reference to FIG. 22, the same components as the components described with reference to FIG. 13 will be assigned with the same reference numerals, and some repetitive details thereof may be omitted to avoid redundancy.

Referring to FIGS. 10 and 22, the input device PN-5 may include the voltage source PM-C, the voltage division circuit V-D, and a switching circuit SWCa located in the housing HS.

The voltage source PM-C may be configured to provide the second voltage signal VTE2 (see FIG. 15) to the first tip electrode TE1 and the second tip electrode TE2. Hereinafter, the second voltage signal VTE2 is referred to as the tip voltage signal VTE2. The signal provided from the voltage source PM-C may be transmitted to the first tip electrode TE1 and the second tip electrode TE2.

The switching circuit SWCa and the voltage division circuit V-D may be connected between the voltage source PM-C and the first connection line CL1. The switching circuit SWCa may be controlled through the control signal CS. The control signal CS may be a signal determined depending on a use condition or a user state of the input device PN-5. The switching circuit SWCa may be turned on or off to transmit the tip voltage signal VTE2 to the voltage division circuit V-D or not. An amplitude (or a magnitude or an intensity) of the tip voltage signal VTE2 transmitted to the voltage division circuit V-D may be relatively reduced and the tip voltage signal VTE2 may be transmitted to the first tip electrode TE1.

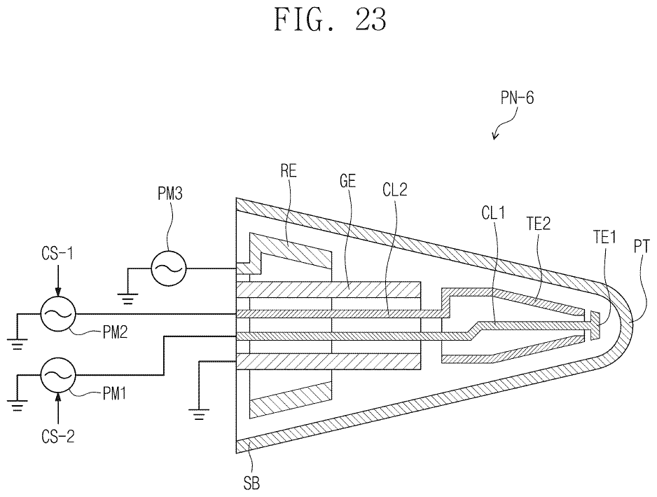

FIG. 23 is a view illustrating an input device PN-6 according to some embodiments of the present disclosure. In the following description made with reference to FIG. 23, the same components as the components described with reference to FIG. 13 will be assigned with the same reference numerals, and some repetitive details thereof may be omitted to avoid redundancy.

Referring to FIGS. 10 and 23, the first voltage source PM1 may be controlled through a first control signal CS-1, and the second voltage source PM2 may be controlled through a second control signal CS-2. Accordingly, the first voltage signal CS-1 and the second voltage signal CS-2 may be provided from a controller CTR-P.

A first voltage signal output from the first voltage source PM1 and a second voltage signal output from the second voltage source PM2 may be changed depending on various scenarios. For example, a frequency, an amplitude, or an output timing of each of the first voltage signal and the second voltage signal may be adjusted. The scenario may be recognized autonomously by the input device PN-6 or received from the sensor driver 200C or the electronic device 1000. The scenario may be understood based on the four scenarios described with reference to FIG. 14.

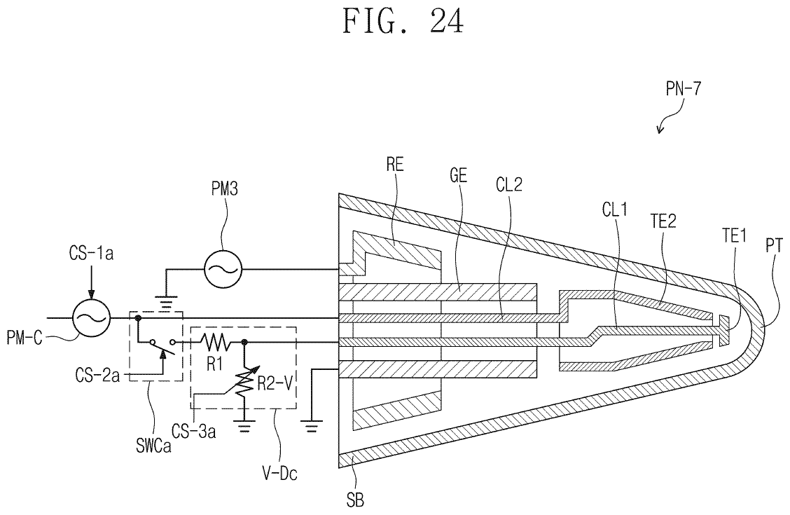

FIG. 24 is a view illustrating an input device PN-7 according to some embodiments of the present disclosure. The following description will be made with reference to FIG. 24 while focusing on the different from the input device PN-5 described with reference to FIG. 22.

Referring to FIGS. 10 and 24, the input device PN-7 may include the voltage source PM-C, a voltage division circuit V-Dc, and the switching circuit SWCa located in the housing HS.

The switching circuit SWCa and the voltage division circuit V-Dc may be connected between the voltage source PM-C and the first connection line CL1.

The voltage division circuit V-Dc may include a first resistor R1 connected between the switching circuit SWCa and the first connection line CL1 and a second resistor R2-V connected to a node between the first resistor R1 and the first connection line CL1. Another terminal of the second resistor R2-V may be grounded. According to some embodiments of the present disclosure, any one of the first resistor R1 and the second resistor R2-V may be a variable resistor. As illustrated in FIG. 24, the second resistor R2-V is a variable resistor by way of example.

According to some embodiments of the present disclosure, the voltage source PM-C may be controlled through a first control signal CS-1a, and the switching circuit SWCa may be controlled through a second control signal CS-2a. In addition, the second resistor R2-V may be configured to have a resistance adjusted through the third control signal CS-3a. The first control signal CS-1a, the second control signal CS-2a, and the third control signal CS-3a may be provided from the controller CTR-P.

A frequency, an amplitude, or an output timing of a voltage signal output from the voltage source PM-C, an on-off timing of the switching circuit SWCa, and the resistance of the second resistor R2-V may be variously changed depending on a scenario. The scenario may be recognized autonomously by the input device PN-7 or received from the sensor driver 200C or the electronic device 1000. The scenario may be understood based on the four scenarios described with reference to FIG. 14.

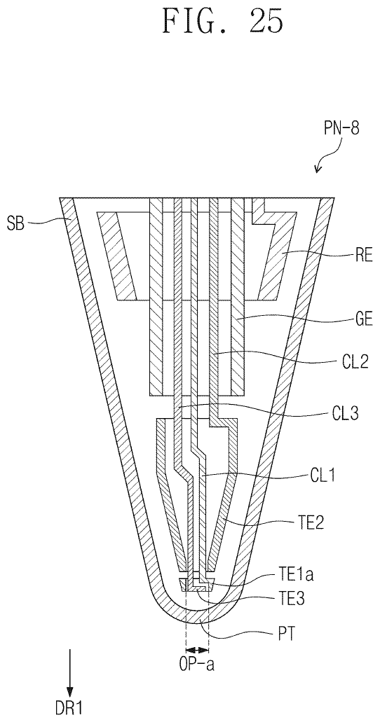

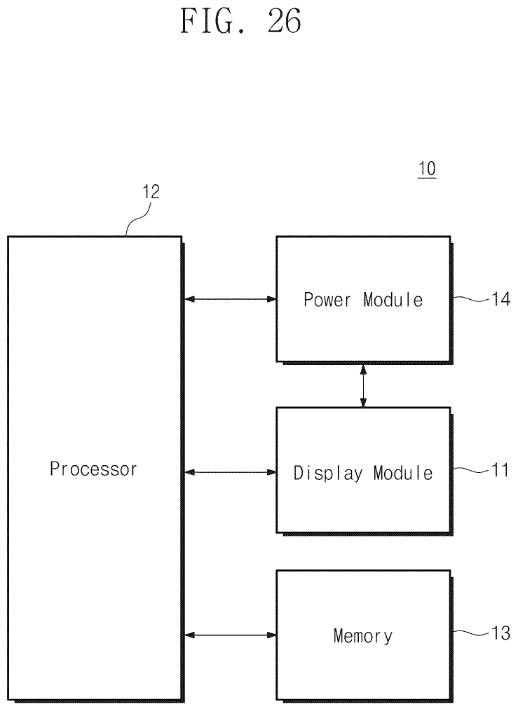

FIG. 25 is a view illustrating an input device PN-8 according to some embodiments of the present disclosure. In the following description made with reference to FIG. 25, the same components as the components described with reference to FIG. 11 will be assigned with the same reference numerals, and some repetitive details thereof may be omitted to avoid redundancy.

Referring to FIGS. 10 and 25, the input device PN-8 may further include a third connection line CL3 and a third tip electrode TE3, when compared to the input device PN illustrated in FIG. 11.

The first tip electrode TE1a and the third tip electrode TE3 may face the pen tip PT. An electrode opening OP-a may be defined in the first tip electrode TE1a, and the third tip electrode TE3 may be located in the electrode opening OP-a. The third connection line CL3 may be connected to the third tip electrode TE3 and may extend toward the body portion BD (see FIG. 10).

According to some embodiments of the present disclosure, as illustrated in FIG. 25, the tip electrode is divided into three parts. However, embodiments according to the present disclosure are not limited thereto. For example, the tip electrode may be divided into at least three parts.

Signals provided to the first tip electrode TE1a, the second tip electrode TE2, and the third tip electrode TE3 may be variously adjusted. For example, in a tilted state, the distance between the sensor layer 200 and the first tip electrode TE1a may be shortest, and the distance between the second tip electrode TE2 and the third tip electrode TE3, and the sensor layer 200 may be longer. In this case, a signal transmitted from the first tip electrode TE1a, which has the shortest distance to the sensor layer 200, to the sensor layer 200 may have the greatest influence on the shape of the electrode. Accordingly, the precision of coordinates may be increased in the tilted state by decreasing the magnitude of the signal provided to the first tip electrode TE1a and increasing the magnitude of the signal provided to each of the second tip electrode TE2 and the third tip electrode TE3.

According to some embodiments of the present disclosure, the sensor driver 200C (see FIG. 5) may calculate coordinates corresponding to the position, which is, for example, the position of the input made by the input device PN-8 inside the sensor layer 200, of the pen tip PT of the input device PN-8 or the coordinates of the input device PN-8, based on the signal received from the first tip electrode TE1a, the signal received from the second tip electrode TE2, and the signal received from the third tip electrode TE3. Accordingly, even if the signal received from the first tip electrode TE1a is distorted depending on the shape of the electrode inside the sensor layer 200, the sensor driver 200C may calculate coordinates using signals received from the first tip electrode TE1a, the second tip electrode TE2, and the third tip electrode TE3, thereby relatively improving the precision of the coordinates.

FIG. 26 is a block diagram of an electronic device 10 according to some embodiments of the present disclosure.

Referring to FIG. 26, the electronic device 10 may correspond to each of electronic devices 1000, 1000-1, and 1000-2 described with reference to FIGS. 1A, 1B, 2, and 3.

According to some embodiments of the present disclosure, the electronic device 10 may include a display module 11, a processor 12, a memory 13, and a power module 14.

The display module 11 may display an image. The image may include a still image in addition to a dynamic image. The display module 11 may include the display panel DP described with reference to FIG. 4. The processor 12 may include at least one a central processing unit (CPU), an application processor (AP), a graphic processing unit (GPU), a communication processor (CP), an image signal processor (ISP), or a controller. The processor 12 may be configured to control the operation of the display module 11.

The memory 13 may store data information necessary for the operation of the processor 12 or the display module 11. When the processor 12 runs the application stored in the memory 13, an image data signal and/or an input control signal may be transmitted to the display module 11, and the display module 11 may process the transmitted signal and output the image information through the display screen.

The power module 14 may include a power supply module, such as a power adapter or a battery device, and a power conversion module which converts power supplied by the power supply module to generate power required for the operation of the electronic device 10.

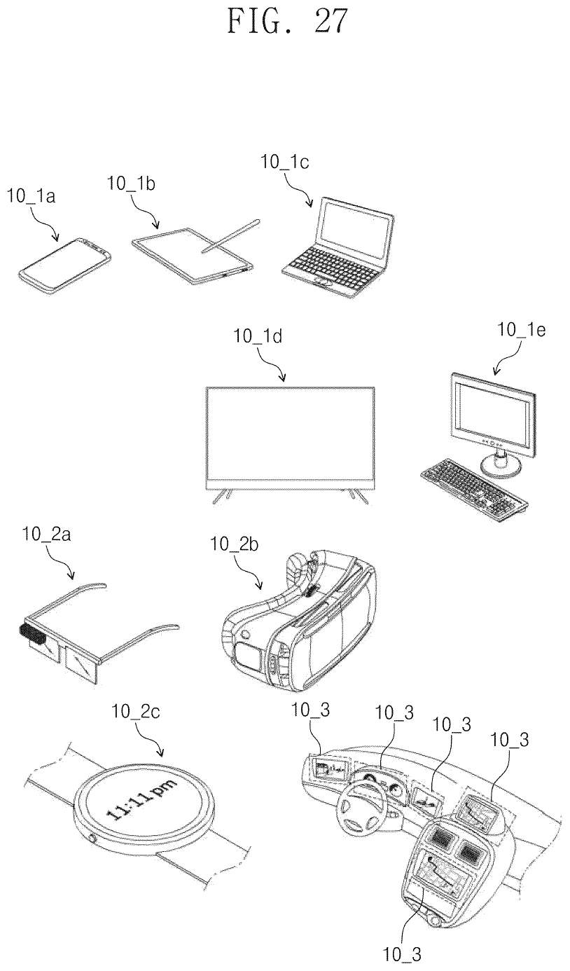

FIG. 27 is a schematic view of an electronic device according to various embodiments.

Referring to FIG. 27, various electronic devices employing display devices according to embodiments may include an electronic device, such as a smartphone 10_1a, a tablet PC 10_1b, a laptop computer 10_1c, a television (TV) 10_1d, and a desk monitor 10_1e, for image display, a wearable electronic device including a display module such as smart glasses 10_2a, a head mounted display 10_2b, and a smart watch 10_2c, and a vehicle electronic device 10_3 including a display module, such as a center information display (CID) placed an instrument panel, a center fascia, or a dashboard of a vehicle or a room mirror display.

As described above, the input device may include the plurality of tip electrodes. Accordingly, the sensor driver of the electronic device may calculate the position of the pen tip of the input device, based on signals received from the plurality of tip electrodes. Accordingly, even if the signal received from one tip electrode is distorted depending on the shape of the electrode inside the sensor layer, the sensor driver may calculate the coordinates by using the signals received from the plurality of tip electrodes, thereby relatively improving the precision of the coordinates.

Although aspects of some embodiments of the present disclosure has been described for illustrative purposes, those skilled in the art will appreciate that various modifications, and substitutions are possible, without departing from the scope and spirit of the present disclosure as disclosed in the accompanying claims. Accordingly, the technical scope of embodiments according to the present disclosure is not limited to the detailed description of this specification, but should be defined by the claims, and their equivalents.

While the present disclosure has been described with reference to embodiments thereof, it will be apparent to those of ordinary skill in the art that various changes and modifications may be made thereto without departing from the spirit and scope of the present disclosure as set forth in the following claims, and their equivalents.

What is claimed is:

1. An input device comprising:
a housing including a body portion and a tapered portion including a pen tip;
a first connection line inside the housing and extending from the body portion toward the pen tip of the tapered portion;
a first tip electrode inside the housing and connected to the first connection line to face the pen tip;
a second tip electrode inside the housing, having an opening allowing the first connection line to pass through the opening, and surrounding the first connection line;
a second connection line inside the housing, connected to the second tip electrode, and extending toward the body portion;
a ground electrode inside the housing and surrounding the first connection line and the second connection line; and
a ring electrode inside the housing and surrounding the ground electrode.

2. The input device of claim 1, wherein the first tip electrode is configured to output a first signal, the second tip electrode configured to output a second signal, and an intensity of the first signal is lower than an intensity of the second signal.

3. The input device of claim 1, further comprising:
a first voltage source inside the housing to provide a first voltage signal to the first tip electrode; and
a second voltage source configured to provide a second voltage signal to the second tip electrode.

4. The input device of claim 3, wherein each of the first voltage signal and the second voltage signal is configured to be converted through a control signal.

5. The input device of claim 3, wherein the first voltage signal has a frequency equal to a frequency of the second voltage signal, and
wherein the first voltage signal and the second voltage signal are in phase.

6. The input device of claim 5, wherein the first voltage signal has an amplitude less than an amplitude of the second voltage signal.

7. The input device of claim 5, wherein a time period for providing the first voltage signal is shorter than a time period for providing the second voltage signal, within a same time duration.

8. The input device of claim 3, further comprising:
a controller configured to separately control a frequency, an amplitude, a phase, and an output timing of the first voltage signal and a frequency, an amplitude, a phase, and an output timing of the second voltage signal.

9. The input device of claim 1, further comprising:
a voltage source in the housing and configured to provide a tip voltage signal to the first tip electrode and the second tip electrode; and
a voltage division circuit interposed between the voltage source and the first connection line.

10. The input device of claim 9, further comprising:
a switching circuit interposed between the voltage source and the voltage division circuit to control a connection between the voltage source and the voltage division circuit.

11. The input device of claim 10, wherein at least one of the tip voltage signal, the switching circuit, or the voltage division circuit is configured to be controlled through a control signal.

12. The input device of claim 11, wherein the voltage division circuit includes:
a first resistor connected between the switching circuit and the first connection line; and
a second resistor connected between a node, which is interposed between the first resistor and the first connection line, and a ground terminal,
wherein one of the first resistor and the second resistor is a variable resistor, and
wherein a resistance of the variable resistor is adjusted through the control signal.

13. A display panel comprising:
a display layer configured to display an image; and
a sensor layer on the display layer,
wherein the sensor layer is configured to output a first signal received from an outside and a second signal received from outside and different from the first signal, and
wherein the first signal and the second signal are used to calculate a position of a pen tip.

14. The display panel of claim 13, wherein the first signal has a frequency equal to a frequency of the second signal,
wherein the first signal and the second signal are in phase, and
wherein the first signal has an amplitude less than an amplitude of the second signal.

15. The display panel of claim 13, wherein each of the first signal and the second signal is an alternating current (AC) signal, and
wherein a length of a duration in which the first signal has a waveform is shorter than a length of a duration in which the second signal has a waveform.

16. The display panel of claim 13, wherein the sensor layer is configured to output a third signal different from the first signal and the second signal and received from the outside, and
wherein the third signal is used to correct a position of the pen tip.

17. An electronic device comprising:
a display panel including a display layer configured to display an image and a sensor layer on the display layer;
a display driver configured to control an operation of the display layer;
a sensor driver configured to control an operation of the sensor layer and to calculate information about a position of a pen tip, based on a first signal provided from the sensor layer and a second signal different from the first signal; and
a main driver configured to control an operation of the display driver and an operation of the sensor driver, and to control an operation of the display driver based on a coordinate signal provided from the sensor driver.

18. The electronic device of claim 17, wherein the first signal has a frequency equal to a frequency of the second signal, the first signal and the second signal are in phase, and the first signal has an amplitude less than an amplitude of the second signal, and
wherein the sensor driver is configured to generate the coordinate signal based on information obtained by adding the first signal and the second signal.

19. The electronic device of claim 17, wherein each of the first signal and the second signal is an alternating current (AC) signal,
wherein a length of a duration in which the first signal has a waveform is shorter than a length of a duration in which the second signal has a waveform, and
wherein the sensor driver generates the coordinate signal based on information obtained by adding the first signal and the second signal.

20. The electronic device of claim 17, wherein the sensor driver is configured to receive a third signal different from the first signal and the second signal and provided from the sensor layer, and to correct a position of the pen tip based on the third signal.
